(19) United States
(12) Patent Application Publication
(10) Pub. No.: US 2019/0139008 A1
(43) Pub. Date: May 9, 2019

(54) Reducing Complexity When Integrating Services Functionalities

(71) Applicant: Digitzs Solutions, Inc., Los Angeles, CA (US)

(72) Inventor: Stacey Moore, Marina del Rey, CA (US)

(73) Assignee: Digitzs Solutions, Inc., Los Angeles, CA (US)

(21) Appl. No.: 15/491,725

(22) Filed: Apr. 19, 2017

Related U.S. Application Data
(60) Provisional application No. 62/324,837, filed on Apr. 19, 2016.

(51) Int. Cl. G06Q 20/10; G06F 9/54; G06Q 20/02

(52) U.S. Cl. CPC G06Q 20/10; G06Q 20/02; G06F 9/547

(57) ABSTRACT

Systems and methods for simplifying the often technically complicated process of managing a service are described. The systems and methods may provide a set of simplified Application Programming Interfaces (APIs) that allow an account manager to provide service information. For example, the systems and methods described herein may allow a non-technical user to create and/or manage services used in an electronic payment ecosystem. The systems and methods described herein provide a unified and systematic review of services information a user provides in order to simplify the often hyper-technical process of error checking service management.

### RELATED APPLICATIONS

This application claims priority to U.S. Provisional Patent Application No. 62/324,837, filed on Apr. 19, 2016, the entire disclosure of which is hereby incorporated by reference.

### BACKGROUND

An active area of research and development is in the reduction of complexity in systems. A huge number of inventions made throughout history have been ways of making machines work better by making them work more efficiently. The reduction of complexity generally leads to a reduction of resources needed to accomplish a given task and improve the probability that any results of the reduced-complexity system will be error-free.

For example, the process of enrolling with a merchant services entity often requires a user to navigate through a series of technically complicated Application Programming Interfaces (APIs), computer error codes that are difficult for a non-technical person to understand, and enrollment procedures that often take technical knowledge to use. While it may be desirable to simplify the technical aspects of managing a merchant service, not many systems have been able to do so.

### BRIEF DESCRIPTION OF THE DRAWINGS

FIG. 1A shows an example of an electronic payments system having merchant services functionalities, according to some implementations.

FIG. 1B shows an example of an electronic payments system having merchant services functionalities, according to some implementations.

FIG. 1C shows an example of an electronic payments system having merchant services functionalities, according to some implementations.

FIG. 1D shows an example of an electronic payments system having merchant services functionalities, according to some implementations.

FIG. 2 shows an example of a data flow depicting the provisioning of merchant services by an electronic payments system, according to some implementations.

FIG. 3 shows an example of a payment processing integration system, according to some implementations.

FIG. 4 shows an example of a simplified merchant account Application Programming Interface (API) engine, according to some implementations.

FIG. 5 shows an example of a payment processing partner system, according to some implementations.

FIG. 6 shows an example of a flowchart of a method for providing instructions to create a merchant account using validated merchant information provided over a simplified merchant account API, according to some implementations.

FIG. 7 shows an example of a flowchart of a method for providing instructions to configure merchant system(s) to accept payment using a merchant account, according to some implementations.

FIG. 8 shows an example of a computer system, according to some implementations.

FIG. 9 shows an example of a screenshot of a list of simplified APIs, according to some implementations.

FIG. 10 shows an example of a screenshot of a simplified API for verifying an API key, according to some implementations.

FIG. 11 shows an example of a screenshot of a simplified API for creating an application key, according to some implementations.

FIG. 12 shows an example of a screenshot of a simplified API for verifying an application token, according to some implementations.

FIG. 13 shows an example of a screenshot of a simplified API for creating an application token, according to some implementations.

FIG. 14 shows an example of a screenshot of a simplified API for listing merchants, according to some implementations.

FIG. 15 shows an example of a screenshot of a simplified API for creating merchants, according to some implementations.

FIG. 16 shows an example of a screenshot of a simplified API for retrieving merchants, according to some implementations.

FIG. 17 shows an example of a screenshot of a simplified API for listing payments, according to some implementations.

FIG. 18 shows an example of a screenshot of a simplified API for creating payments, according to some implementations.

FIG. 19 shows an example of a screenshot of a simplified API for retrieving payments, according to some implementations.

FIG. 20 shows an example of a screenshot of a simplified API for listing customers, according to some implementations.

FIG. 21 shows an example of a screenshot of a simplified API for creating customers, according to some implementations.

FIG. 22 shows an example of a screenshot of a simplified API for retrieving customers, according to some implementations.

FIG. 23 shows an example of a screenshot of a simplified API for listing tokens, according to some implementations.

FIG. 24 shows an example of a screenshot of a simplified API for creating tokens, according to some implementations.

FIG. 25 shows an example of a screenshot of a simplified API for retrieving tokens, according to some implementations.

### SUMMARY

The present disclosure provides for a system including an electronic parameter request engine configured to gather one or more services parameters. Each of the one or more services parameters provides a basis for services information obtained from a services management system. The system also includes a simplified services engine Application Programming Interface (API) engine. This engine is configured to obtain one or more simplified services APIs, each of the one or more simplified services APIs configured to facilitate gathering services information used to establish the services parameters. The engine is also configured to provide the simplified services APIs to be displayed in an account management system and receive the simplified services APIs to be displayed in an account management system. The system further includes an electronic account information validation engine. This engine is configured to obtain one or more validation parameters, each of the one or more validation parameters configured to provide a basis for validating the services information. This engine is also configured to evaluate the services for validation in accordance with the validation parameters. The system also includes an electronic account error reporting engine. This engine is configured to provide, if the services information was not validated in accordance with the validation parameters, a unified error report based on the validation parameters. The unified error report identifying all errors in the services information. The system also includes an electronic account instruction management engine configured to provide instructions to create an account using validated services information provided over the simplified services APIs.

The present disclosure also provides a method. The method includes gathering one or services parameters. Each of the one or more services parameters provides a basis for services information obtained from a services management system. The method also includes obtaining one or more simplified services Application Programming Interfaces (APIs). Each of the one or more simplified services APIs are configured to facilitate gathering services information used to establish the services parameters. The method further includes providing the simplified services APIs to be displayed in an account management system and receiving the simplified services APIs to be displayed in an account management system. The method also includes obtaining one or more validation parameters. Each of the one or more validation parameters configured to provide a basis for validating the services information. The method further includes evaluating the services for validation in accordance with the validation parameters. If the services information was not validated in accordance with the validation parameters, the method provides a unified error report based on the validation parameters. The unified error report identifying all errors in the services information. The method also includes providing instructions to create an account using validated services information provided over the simplified services APIs.

### DETAILED DESCRIPTION

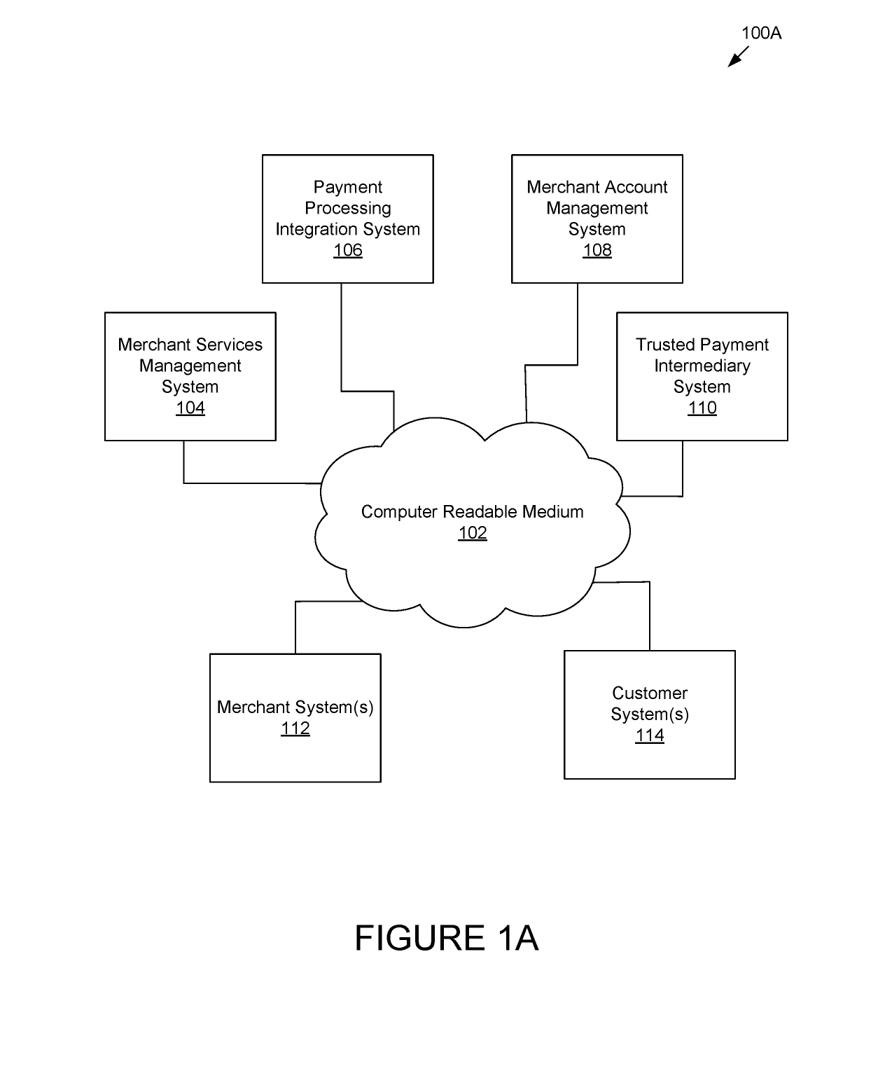

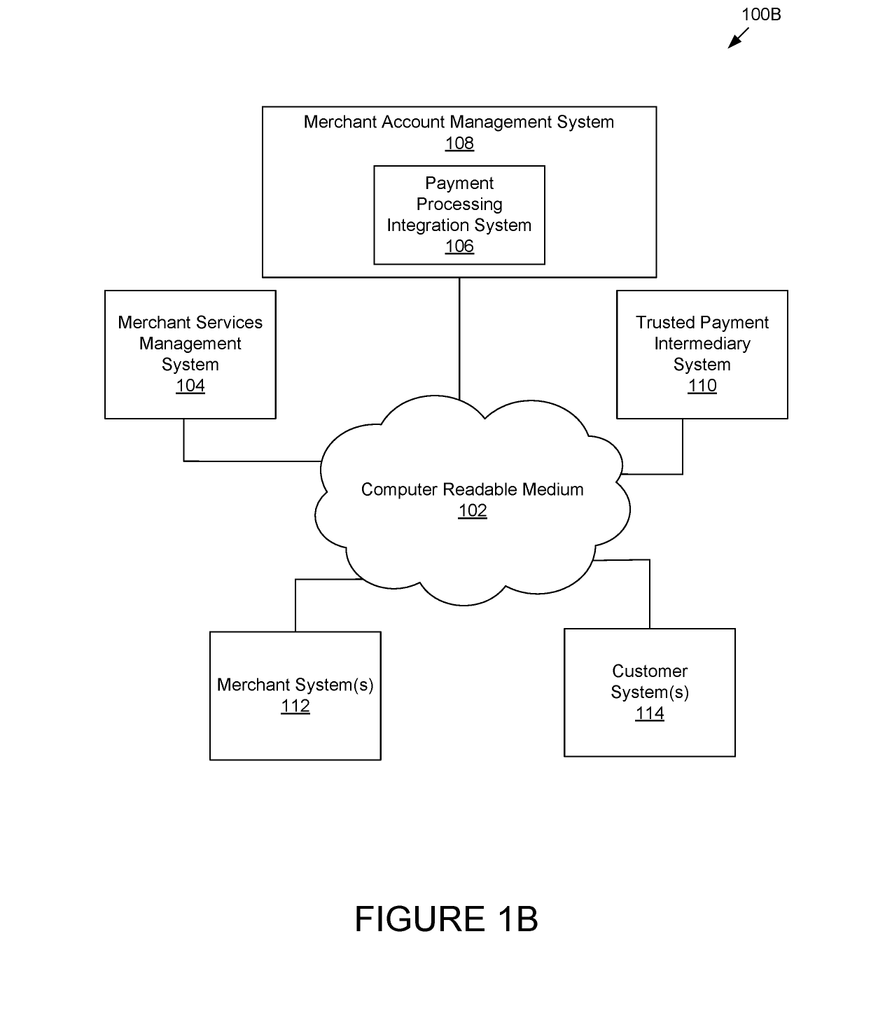

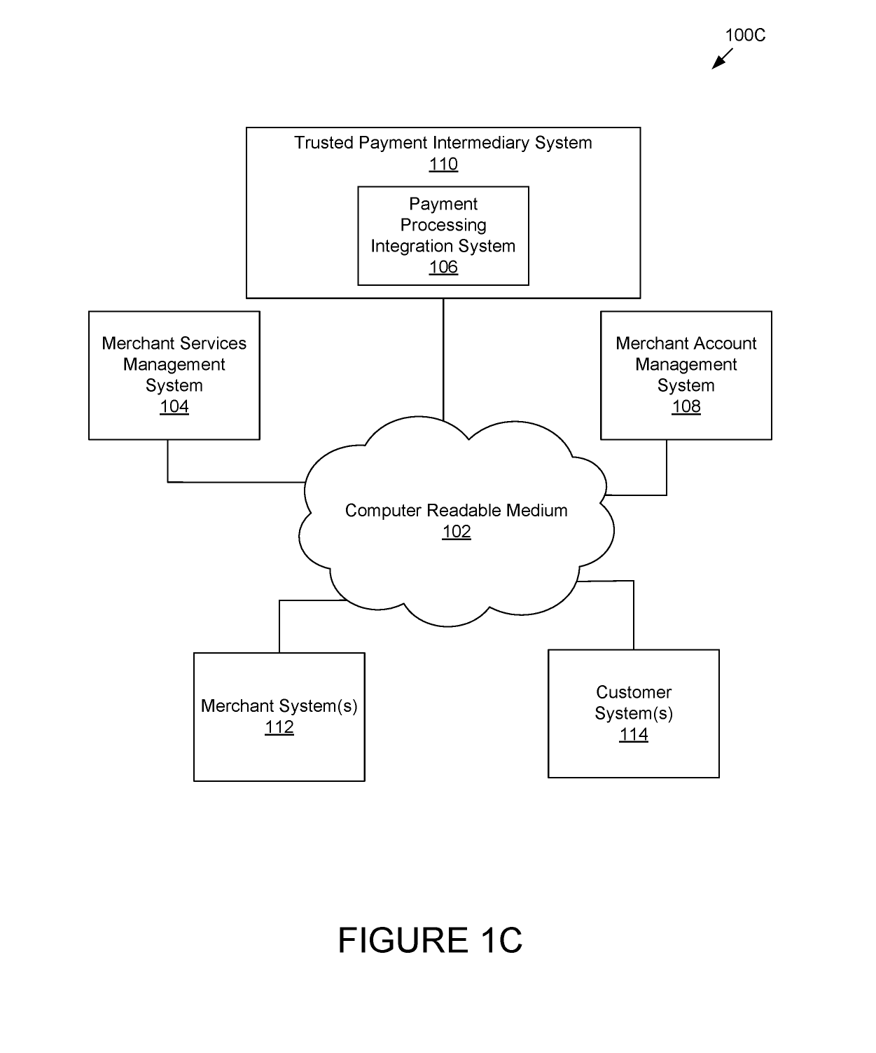

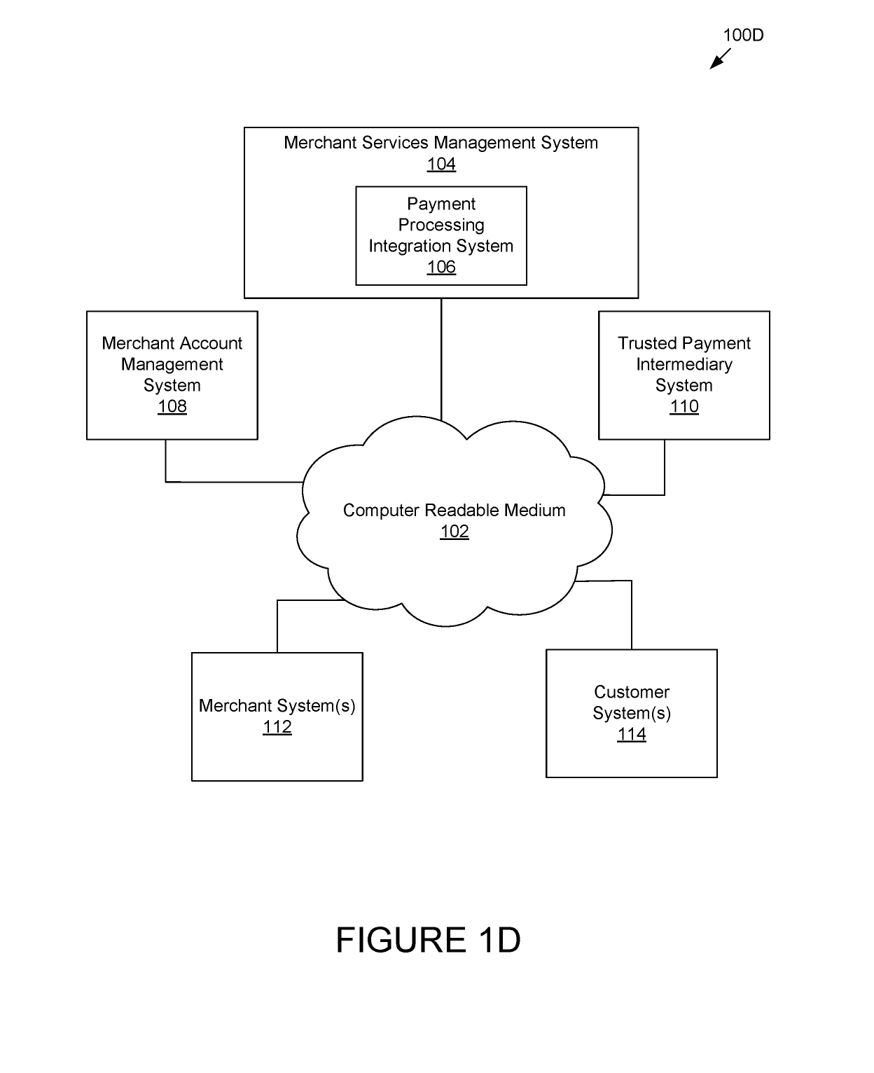

Examples throughout this paper make reference to merchant and payments systems, but the techniques are applicable to other systems for the purpose of reducing complexity. FIGS. 1A, 1B, 1C, and 1D show examples of an electronic payments system 100. It is noted the electronic payments system 100 may be arranged according to one or more of the examples of FIGS. 1A, 1B, 1C, and 1D, some combination thereof, or in accordance with an arrangement not explicitly shown in FIGS. 1A, 1B, 1C, and 1D. FIG. 1A shows an example of an electronic payments system 100A having merchant services functionalities, according to some implementations. In the example of FIG. 1A, the electronic payments system 100A includes a computer-readable medium 102, a merchant services management system 104, a payment processing integration system 106, a merchant account management system 108, a trusted payment intermediary system 110, merchant system(s) 112, and customer system(s) 114. In the example of FIG. 1A, the computer-readable medium 102 is coupled to the merchant services management system 104, the payment processing integration system 106, the merchant account management system 108, the trusted payment intermediary system 110, the merchant system(s) 112, and the customer system(s) 114.

The computer-readable medium 102 and other computer readable mediums discussed in this paper are intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The computer-readable medium 102, the merchant services management system 104, the payment processing integration system 106, the merchant account management system 108, the trusted payment intermediary system 110, the merchant system(s) 112, and the customer system(s) 114, and other applicable systems or devices described in this paper can be implemented as a computer system or parts of a computer system or a plurality of computer systems. A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. Depending upon implementation-specific or other considerations, the I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

A computer system can be implemented as an engine, as part of an engine or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

In the example of FIG. 1A, the merchant services management system 104 is coupled to the computer-readable medium 102. In various implementations, the merchant services management system 104 includes one or more automated agents that provide merchant services to the merchant system(s) 112. A “merchant service,” as used herein, may refer to a service used to enable businesses to accept payments through a channel, such as a as a secure channel, an encrypted channel, a channel using a credit card, debit card, Near Field Communications (NFC) enabled device, Radio Frequency Identification (RFID) enabled device, a biometric device, etc. The merchant service may be linked to a credit card account, a debit card, an Automated Clearing House (ACH) account, etc.

In an implementation, the merchant services management system 104 enables merchants associated with the merchant system(s) 112 to setup merchant accounts that accept electronic payment. A “merchant account,” as used herein, may refer to an account that a merchant uses to accept payment for a good or service. In various implementations, the merchant accounts setup by the merchant services management system 104 can be set up online and/or accept forms of payment (credit cards, debit cards, etc.) without special equipment or the requirement that the merchants make long term commitments and/or investments. In some implementations, the merchant services management system 104 supports mobile and/or card readers (or other hardware at the merchant system(s) 112.

In some implementations, the merchant services management system 104 supports security and/or other protocols on the merchant system(s) 112. Examples of security and/or other protocols that may be supported include protocols related to encryption and/or tokenization of data used for transactions at the merchant system(s) 112. In an implementation, the merchant services management system 104 protects and/or tokenizes financial data, such as data related to credit card payments and/or ACH payment data. In some implementations, the merchant services management system 104 protects the data to the merchant system(s) 112 outside of any transaction processing stream by tokenizing this information.

In the example of FIG. 1A, the payment processing integration system 106 is coupled to the computer-readable medium 102. In an implementation, the payment processing integration system 106 includes one or more automated agents that integrate actions of a user of the merchant account management system 108 with the merchant services management system 104. In various implementations, the automated agents in the payment processing integration system 106 provide the merchant account management system 108 with a set of simplified Application Programming Interfaces (APIs) that allow the merchant account management system 108 to provide merchant service information used as the basis of merchant services that the merchant account management system is creating and/or otherwise managing.

In the example of FIG. 1A, the merchant account management system 108 is coupled to the computer-readable medium 102. In various implementations, the merchant account management system 108 includes one or more automated agents to interface with a user, such as a user seeking to access merchant service functionalities supported by the merchant services management system 104. The merchant account management system 108 may include a computer system, such as a mobile phone, a tablet, a laptop computer, or a desktop computer. The merchant account management system 108 may receive from the user merchant service information. “Merchant service information,” as used herein, may refer to any information that is relevant to the establishment or management of a merchant service. Examples of merchant service information include information related to authorization protocols for merchant accounts, information related to the establishment or the management of merchant accounts, information related to payments processes for merchant accounts, information related to management of customers related to merchant accounts, and information related to tokens used for purchases from the merchant accounts.

The merchant account management system 108 may be associated with a specific industry or set of industries. As an example, the merchant account management system 108 may be managed by an entity seeking to develop an application for event vendors to accept electronic payments, credit cards, etc. for tickets to events. The merchant account management system 108 may further be managed by an entity seeking to develop an application for any business that wants to accept electronic payments, credit cards, etc. for goods or services but is unable to directly establish a merchant account with the trusted payment intermediary system 110 (e.g., due to risk, capital requirements, size of operations, etc.). In some implementations, the merchant account management system 108 is associated with an entity that provides small businesses who want to accept electronic payments, credit cards, etc. with payment management or accounting software. The merchant account management system 108 may be associated with an entity that wants to allow landlords to accept electronic payments, credit cards, etc. The merchant account management system 108 may be associated with a company that wants to allow a ride-sharing service to collect electronic payments, credit cards, etc., and may or may not want to return some revenue collected to drivers. It is noted the merchant account management system 108 may operate in various other industries as well.

In the example of FIG. 1A, the trusted payment intermediary system 110 is coupled to the computer-readable medium 102. In some implementations, the trusted payment intermediary system 110 includes automated agents configured to support a transaction between the merchant system(s) 112 and the customer system(s) 114. The trusted payment intermediary system 110 may include digital devices associated with a credit card account, a debit card account, an ACH account, etc. of a merchant account associated with the merchant system(s) 114. In some implementations, the merchant account is established and/or otherwise managed by the merchant services management system 104 through use of the techniques described herein. The trusted payment intermediary system 110 may, in various implementations, facilitate transfer of funds to the merchant accounts for goods and/or services provided to a customer (e.g., a user of the customer system(s) 114).

In the example of FIG. 1A, the merchant system(s) 112 are coupled to the computer-readable medium 102. In some implementations, the merchant system(s) 112 include automated agents configured to support merchant accounts that in turn support electronic payments for goods and/or services provided by users of the merchant system(s) 112. As an example, the merchant system(s) 112 may comprise encrypted card readers (e.g., mobile card readers), NFC/RFID readers, biometric scanners, etc. that allow merchants (e.g., small merchants) to process payments. In an implementation, the encrypted card readers (e.g., mobile card readers), NFC/RFID readers, biometric scanners, etc. on the merchant system(s) 112 may be coupled to the merchant system(s) 112 through a device or other port on the merchant system(s) 112.

In an implementation, the merchant system(s) 112 include secure card etc. readers that accept credit cards, debit cards, ACH information, etc. in a simple, secure and affordable way. The merchant system(s) 112 may, for instance support smartphone payments, phone web interface payments, card reader-based payments, card payments, etc. In some implementations, the merchant system(s) 112 include automated agents that securely process credit card, etc. payments in real-time using a mobile operating system on the merchant system(s) 112. In some implementations, the merchant system(s) 112 include an application (e.g., a mobile application) that includes automated agents configured to accept credit cards etc. payments anywhere. The application may be downloaded from an application store and/or be part of a web page supported by the merchant system(s) 112. As an example, a web browser interface may provide merchants with the ability to see their account summary including account balance, transactions in process, processing limit remaining and transfer funds to their merchant accounts.

In the example of FIG. 1A, the customer system(s) 114 are coupled to the computer-readable medium. The customer system(s) 114 may include any digital device that include automated agents configured to allow customers to purchase goods and/or services from the merchant system(s) 112. In various implementations, the customer system(s) 114 include NFC/RFID chips that can be coupled to the merchant system(s) 112. The customer system(s) 114 may also include Europay, MasterCard, and Visa (EMV) chips and/or other chip-enabled cards. In some implementations, the customer system(s) 114 may comprise a source of biometric information for a purchase.

FIG. 1B shows an example of an electronic payments system 100B having merchant services functionalities, according to some implementations. Components with reference numerals alike the reference numerals in FIG. 1A may have similar functionalities. In the example of FIG. 1B, the merchant account management system 108 comprises the payment processing integration system 106. As an example, in some implementations, the merchant account management system 108 may implement one or more automated agents that correspond to the automated agents of the payment processing integration system 106.

FIG. 1C shows an example of an electronic payments system 100C having merchant services functionalities, according to some implementations. Components with reference numerals alike the reference numerals in FIG. 1A may have similar functionalities. In the example of FIG. 1C, the trusted payment intermediary system 110 comprises the payment processing integration system 106. As an example, in some implementations, the trusted payment intermediary system 110 may implement one or more automated agents that correspond to the automated agents of the payment processing integration system 106.

FIG. 1D shows an example of an electronic payments system 100D having merchant services functionalities, according to some implementations. Components with reference numerals alike the reference numerals in FIG. 1A may have similar functionalities. In the example of FIG. 1D, the merchant services management system 104 comprises the payment processing integration system 106. As an example, in some implementations, the merchant services management system 104 may implement one or more automated agents that correspond to the automated agents of the payment processing integration system 106.

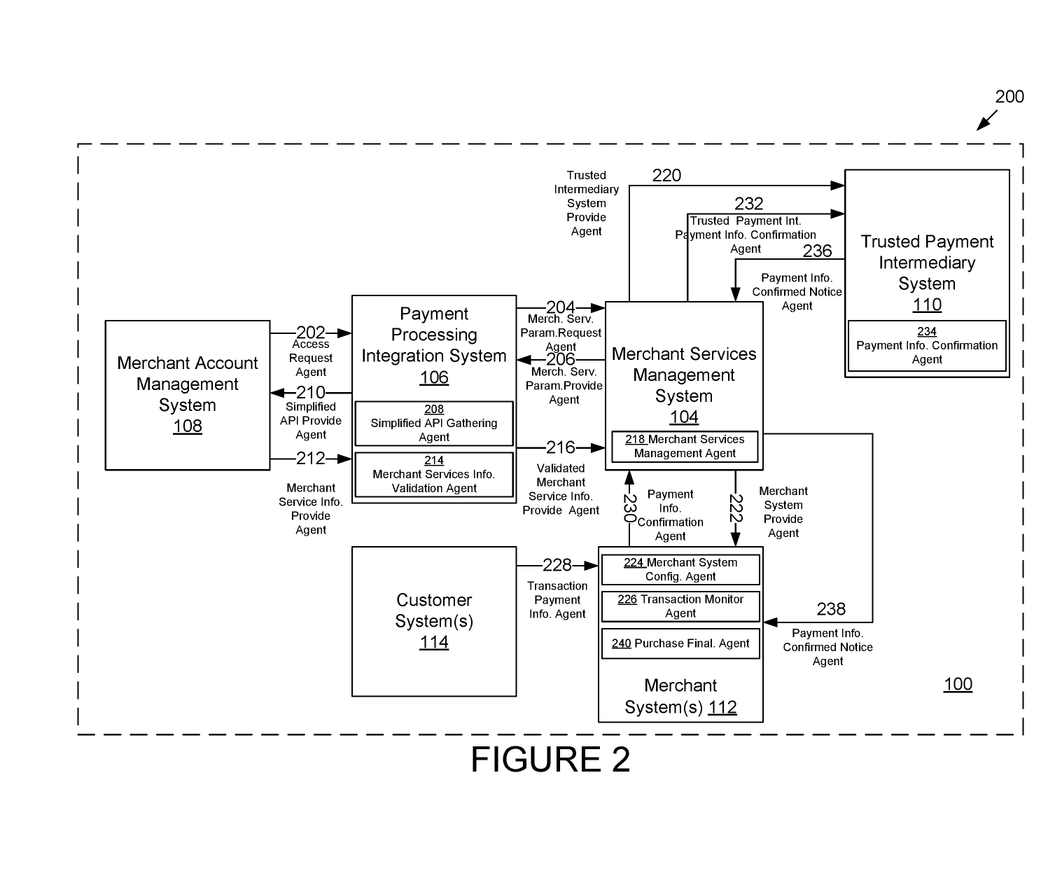

FIG. 2 shows an example of a data flow 200 depicting the provisioning of merchant services by the electronic payments system 100, according to some implementations. In the example of FIG. 2, the data flow 200 includes one or more components of the electronic payments system 100, including the merchant services management system 104, the payment processing integration system 106, the merchant account management system 108, the trusted payment intermediary system 110, the merchant system(s) 112, and the customer system(s) 114.

In an implementation, the merchant account management system 108 may access an access request agent 202 implemented by the payment processing integration system 106 to request access to the payment processing integration system 106. The access request agent 202 may provide the payment processing integration system 106 with information related to the creator of one or more merchant accounts. As an example, the access request agent 202 may provide the payment processing integration system 106 with information about a creator of merchant accounts for a specific industry or set of industries. The access request agent 202 may further provide the payment processing integration system 106 with account information about merchant account creator, etc.

In an implementation, the payment processing integration system 106 may implement a payment processing request agent 204 to request merchant services parameters from the merchant services management system 104. “Merchant services parameters,” as used herein, may refer to parameters that form the basis of merchant service information. The merchant services parameters may include parameters that allow the merchant system(s) 112 to accept payment for a good or a service. Examples of merchant services parameters are information related to authorizations, merchants, payments, customers, and tokens. In an implementation, merchant services management system 104 implements a merchant service parameter response agent 206 to provide the merchant services parameters to the payment processing integration system 106. The merchant service parameter response agent 206 may specify authorizations, merchants, payments, customers, tokens, etc. for the merchant services parameters.

In some implementations, the payment processing integration system 106 may implement a simplified API gathering agent 208 to gather simplified APIs for the merchant services parameters. The simplified APIs include one or more APIs for managing authorization protocols to the payment processing partner system, one or more APIs for establishing and/or otherwise managing merchant accounts, on the payment processing partner system, one or more APIs for managing payments processes of merchant accounts on the payment processing partner system, one or more APIs for managing customer processes on the payment processing partner system, one or more APIs for managing tokens for transactions related to merchant accounts on the payment processing partner system, etc. One or more of the APIs may include Representational State Transfer (REST) and/or other APIs that are compatible with JavaScript Object Notation (JSON), Extensible Markup Language (XML), HyperText Markup Language (HTML), and/or other formats.

The simplified API gathering agent 208 may identify one or more simplified APIs that are sufficient to allow the merchant account management system 108 to provide merchant service information in response to the merchant services parameters. The payment processing integration system 106 may implement a simplified API providing agent 210 to provide the simplified APIs to the merchant account management system 108. In an implementation, the merchant account management system 108 may implement a merchant service providing agent 212 to provide merchant service information to the payment processing integration system 106 through the simplified APIs.

In some implementations, the payment processing integration system 106 may implement a merchant services information validation agent 214 to validate the merchant service information. The merchant services information validation agent 214 may review the entire set of merchant account information and determine whether or not any errors exist in the merchant account information. The merchant services information validation agent 214 may further provide the merchant account management system 108 with a unified error report that lists all errors in the merchant service information so that a user of the merchant account management system 108 has a chance to modify the merchant service information before the merchant service information is provided to the merchant services management system 104.

An in implementation, the payment processing integration system 106 may implement a validated merchant services information providing agent 216 to provide validated merchant service information to the merchant services management system 104. Advantageously, the validated merchant services information will have been validated, and as a result, will not result in run-time or other errors when attempting to create a merchant account (see below).

In some implementations, the merchant services management system 104 may implement a merchant services management agent 218 to manage merchant services in accordance with the validated merchant services information. The merchant services may be managed according to authorizations, merchants, payments, customers, tokens, etc. provided through the simplified APIs. As examples, merchant services may be created, authorization protocols may be specified, merchant accounts may be created and/or managed, customer accounts may be created and/or managed, and tokens may be specified for payment processes. In some implementations, the merchant services management system 104 implements a trusted intermediary system provide agent 220 that provides the trusted payment intermediary system 110 with the merchant services information.

In an implementation, the merchant services management system 104 may implement a merchant system providing agent 222 that provides the merchant services information to the merchant system(s) 112. In an implementation, the merchant system(s) 112 may implement a merchant system configuration agent 224 that configures the merchant systems in accordance with the merchant services. The merchant system(s) 112 may further implement a transaction monitor agent 226 that monitors the merchant system(s) 112 for transactions from the customer system(s) 114. In various implementations, the transaction monitor agent 226 provides a notification if a transaction for which payment is required has occurred on the merchant system(s) 112.

In a specific implementation, the customer system(s) 114 implements a transaction payment information agent 228 that provides corresponds to a transaction that has occurred between the customer system(s) 114 and the merchant system(s) 112. The merchant system(s) 112 may further implement a payment information confirmation agent 230 that provides payment confirmation information to the merchant services management system 104. The merchant services management system 104 may implement a trusted payment intermediary payment information confirmation agent 232 that provides the payment information to the trusted payment intermediary system 110.

In an implementation, the payment processing integration system 106 may implement a payment information confirmation agent 234 that confirms the payment. In an implementation, the trusted payment intermediary system 110 implements a payment information confirmation notice agent 236 that informs the merchant services management system 104 whether or not the payment was confirmed. The merchant services management system 104 may implement a payment information confirmation notice agent 238 that in turn informs the merchant system(s) 112 whether or not the payment was confirmed. In various implementations, the merchant system(s) 112 may implement a purchase finalization agent 240 that finalizes the purchase and allows the transaction to be finalized between the merchant system 112 and the customer system 114.

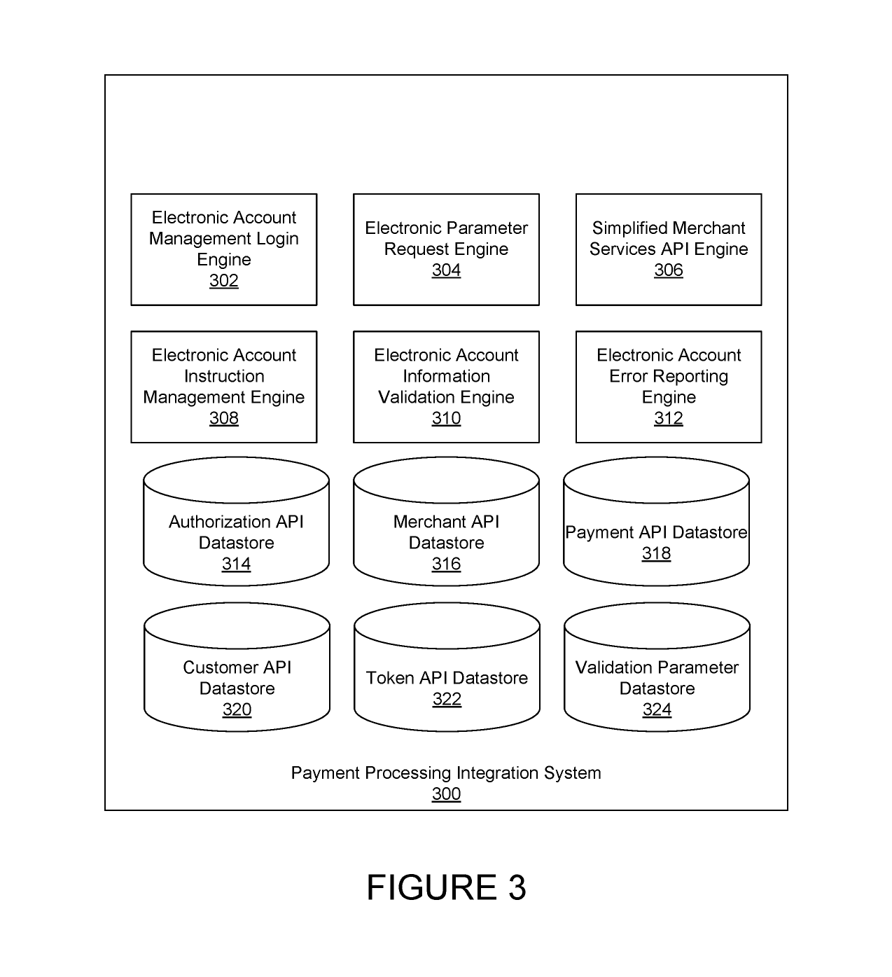

FIG. 3 shows an example of a payment processing integration system 300, according to some implementations. In the example of FIG. 3, the payment processing integration system 300 includes an electronic account management login engine 302, an electronic parameter request engine 304, a simplified merchant services API engine 306, an electronic account instruction management engine 308, an electronic account information validation engine 310, an electronic account error reporting engine 312, an authorization API datastore 314, a merchant API datastore 316, a payment PI datastore 318, a customer API datastore 320, a token API datastore 322, and a validation parameter datastore 324. One or more of the electronic account management login engine 302, the electronic parameter request engine 304, the simplified merchant services API engine 306, the electronic account instruction management engine 308, the electronic account information validation engine 310, the electronic account error reporting engine 312, the authorization API datastore 314, the merchant API datastore 316, the payment API datastore 318, the customer API datastore 320, the token API datastore 322, and the validation parameter datastore 324 may be coupled to one another or to other elements not explicitly shown. One or more of the electronic account management login engine 302, the electronic parameter request engine 304, the simplified merchant services API engine 306, the electronic account instruction management engine 308, the electronic account information validation engine 310, and the electronic account error reporting engine 312 may include an “engine,” as described further herein. One or more of the authorization API datastore 314, the merchant API datastore 316, the payment API datastore 318, the customer API datastore 320, the token API datastore 322, and the validation parameter datastore 324 may include a “datastore,” as described further herein.

In an specific implementation, the electronic account management login engine 302 is configured to implement agents that allow other systems to access the payment processing integration system 300. In an implementation, the electronic account management login engine 302 implements an access request agent that allows access to the payment processing integration system 300. The access request agent may allow other systems (such as a merchant account management system) to login to the payment processing integration system 300 and access merchant account service management functionalities. The access request agent may allow management of credentials etc. associated with merchant services creation and/or management.

In a specific implementation, the electronic parameter request engine 304 is configured to implement agents that request and receive merchant services parameters. In some implementations, the electronic parameter request engine 304 implements a payment processing request agent that requests merchant services parameters from a merchant services management system on behalf of the payment processing integration system 300. The payment processing request agent may include a request for the types of information needed to establish merchant services. In various implementations, the electronic parameter request engine 304 implements a merchant service parameter response agent that obtains merchant services parameters from a merchant services management system. The merchant service parameter response agent may receive a response to a request sent by the payment processing request agent.

In a specific implementation, the simplified merchant services API engine 306 is configured to implement agents that manage simplified APIs used as the basis of merchant services. In some implementations, the simplified merchant services API engine 306 implements a simplified API gathering agent that gathers simplified APIs from one or more of the authorization API datastore 314, the merchant API datastore 316, the payment API datastore 318, the customer API datastore 320, and the token API datastore 322. In some implementations, the simplified merchant services API engine 306 implements a simplified API providing agent that provides simplified APIs to a merchant account management system. The simplified API providing agent may provide the simplified APIs to be displayed on a web browser, a mobile application, an application, etc. on the merchant account management system.

In a specific implementation, the electronic account instruction management engine 308 is configured to implement agents that manage merchant service information. As an example, in some implementations, the electronic account instruction management engine 308 implements merchant service information providing agents that receive merchant service information from a merchant account management system. As another example, the electronic account instruction management engine 308 may provide validated or other forms of merchant service information to a merchant services management system.

In a specific implementation, the electronic account information validation engine 310 may implement agents that identify errors in merchant service information. In some implementations, the electronic account information validation engine 310 implements a merchant account information validation agent that validates merchant service information. The merchant services information validation agent may review merchant service information provided over the simplified APIs to determine whether or not the merchant service information contains errors. In an implementation, the merchant services information validation agent may review specific merchant services information for all errors that may reside in the merchant services information, the electronic account information validation engine 310 may further implement validated merchant services information providing agents that provide validated merchant services information to a merchant services management system.

In a specific implementation, the electronic account error reporting engine 312 may implement agents that report errors in merchant services information. In some implementations, the electronic account error reporting engine 312 implements an error reporting agent that provides a merchant account management system with the errors identified in merchant service information by a merchant services information agent.

In a specific implementation, the authorization API datastore 314 stores templates of authorization APIs. In a specific implementation, the merchant API datastore 316 stores templates of merchant APIs. In a specific implementation, the payment API datastore 318 stores templates of payment APIs. In a specific implementation, the customer API datastore 320 stores templates of customer APIs. In a specific implementation, the token API datastore 322 stores templates of token APIs. In a specific implementation, the validation parameter datastore 324 stores validation parameters.

In various implementations, the payment processing integration system 300 operates to allow a merchant account management system to access a merchant services management system as described herein. In an implementation, the electronic account management login engine 302 operates to implement an access request agent that allows the merchant account management system to request access to the merchant services management system. The electronic parameter request engine 304 may operate to implement a merchant services parameter request agent that requests merchant services parameters from the merchant services management system. In some implementations, the electronic parameter request engine 304 may further operate to implement a merchant services parameter providing agent that receives merchant services parameters from the merchant services management system.

The simplified merchant services API engine 306 may operate to implement a simplified API gathering agent that gather simplified APIs from one or more of the authorization API datastore 314, the merchant API datastore 316, the payment API datastore 318, the customer API datastore 320, and the token API datastore 322. In various implementations, the simplified APIs gathered may include APIs that relate to authorization functions, merchant functions, payment functions, customer functions, token functions, etc.

The electronic account instruction management engine 308 may operate to implement a simplified API providing agent that provides the simplified APIs to the merchant account management system. The electronic account instruction management engine 308 may operate to implement a merchant services information providing agent that receives information related to merchant services to be established using the simplified APIs. In various implementations, the electronic account information validation engine 310 may operate to implement a merchant services information validation agent that validates the merchant services information provided by the merchant account management system. The validation may be performed based on validation parameters obtained from the validation parameter datastore 324, as noted further herein. As also noted herein, the validation may review all portions of the merchant services information to identify all errors (if these errors exist) in the merchant services information. The electronic account error reporting engine 312 may return errors to the merchant account management system. The electronic account instruction management engine 308 may operate to implement a validated merchant service information providing agent that provides validated merchant service information to the merchant services management system.

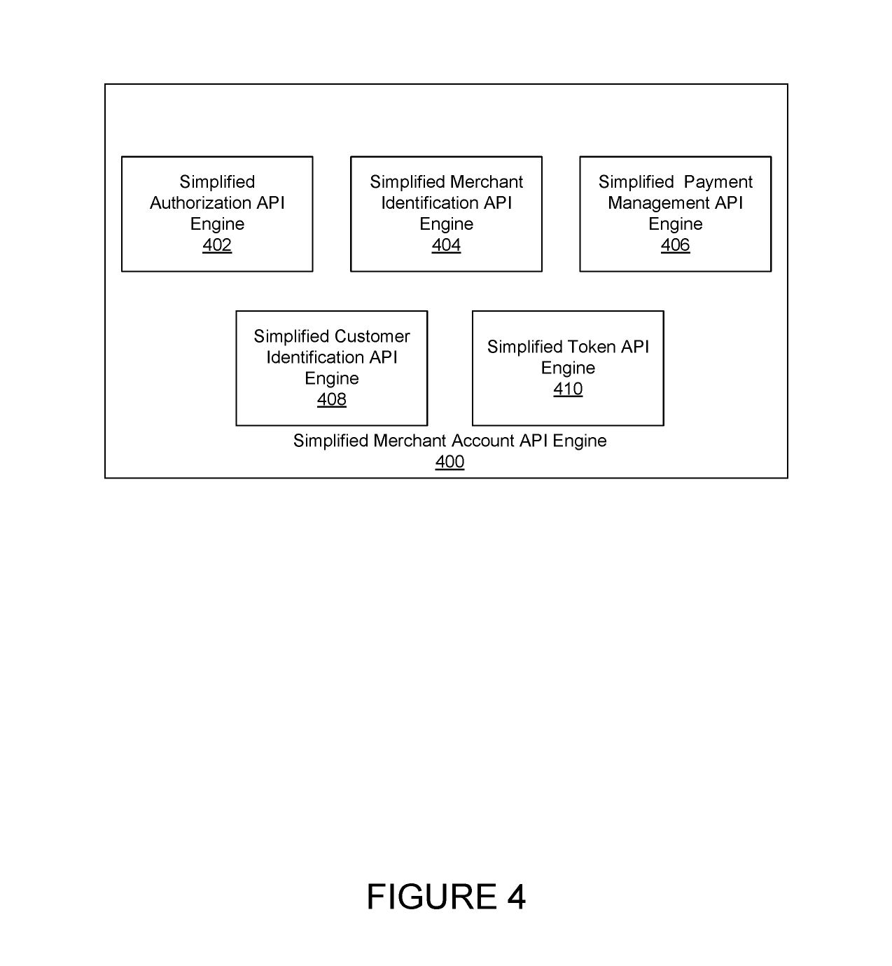

FIG. 4 shows an example of a simplified merchant account API engine 400, according to some implementations. In the example of FIG. 4, the simplified merchant account API engine 400 includes a simplified authorization API engine 402, a simplified merchant identification API engine 404, a simplified payment management API engine 406, a simplified customer identification API engine 408, and a simplified token API engine 410. One or more of the simplified authorization API engine 402, the simplified merchant identification API engine 404, the simplified payment management API engine 406, the simplified customer identification API engine 408, and the simplified token API engine 410 may be coupled to one another or to modules not explicitly shown. One or more of the simplified authorization API engine 402, the simplified merchant identification API engine 404, the simplified payment management API engine 406, the simplified customer identification API engine 408, and the simplified token API engine 410 may include an “engine,” as described further herein.

In a specific implementation, the simplified authorization API engine 402 may gather from the authorization API datastore 314 authorization information over simplified authorization APIs. The simplified merchant identification API engine 404 may gather from the merchant API datastore 316 merchant information from simplified merchant APIs. The simplified payment management API engine 406 may gather from the payment API datastore 318 payment information over simplified payment APIs. The simplified customer identification API engine 408 may gather from the customer API datastore 320 customer information over simplified customer APIs. The simplified token API engine 410 may gather from the token API datastore 322 token information over simplified token APIs.

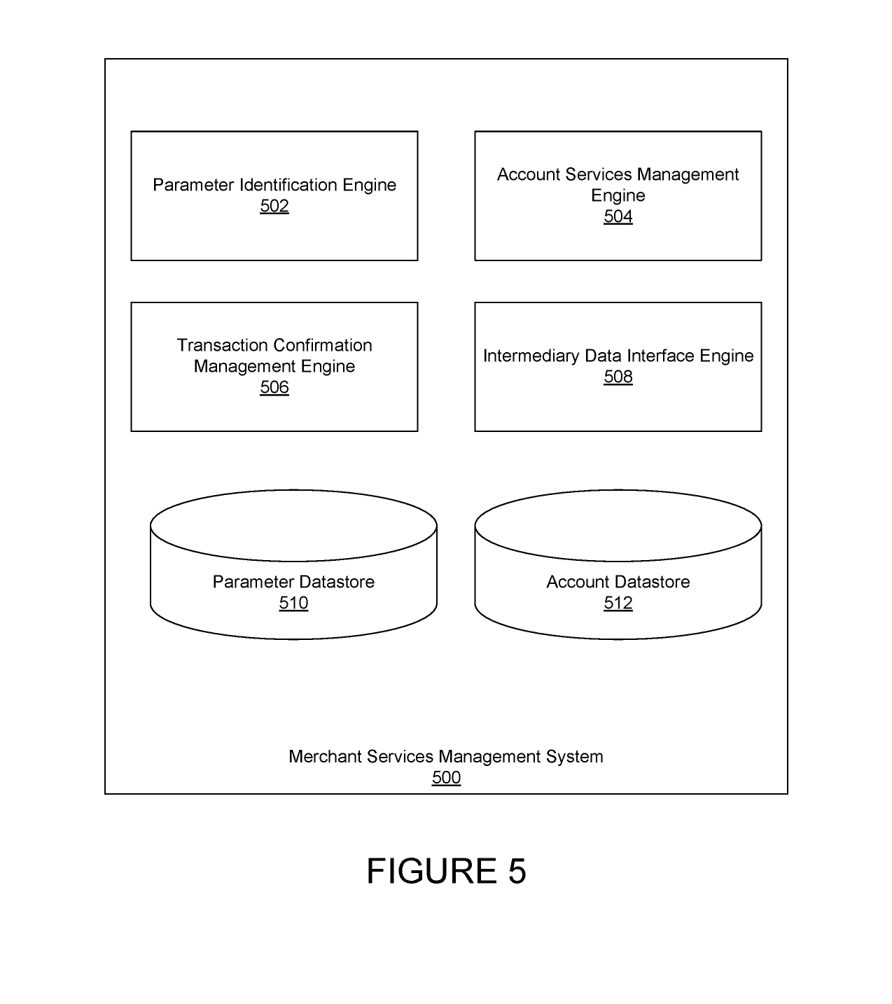

FIG. 5 shows an example of a merchant services management system 500, according to some implementations. In the example of FIG. 5, the merchant services management system 500 includes a parameter identification engine 502, an account services management engine 504, a transaction confirmation management engine 506, an intermediary data interface engine 508, a parameter datastore 510, and an account datastore 512. One or more of the components in FIG. 5 may be coupled to one another or to components not explicitly shown. One or more of the components in FIG. 5 may include an “engine,” or a “datastore,” as defined herein.

In a specific implementation, the parameter identification engine 502 implements a merchant services parameter providing agent that provides merchant services parameters to a payment processing integration system. The merchant services parameter providing agent may provide the merchant services parameters in response to a merchant services parameter, such as a merchant services parameter requested by a payment processing integration system.

In various implementations, the account services management engine 504 implements a merchant services management agent that manages merchant services in accordance with merchant service information provided, from, e.g., a payment processing integration system. The merchant services management engine may create, modify, delete, and/or manage parameters of merchant accounts. In an implementation, the account services management engine 504 supports a merchant system providing agent that allows merchant systems to be configured with merchant services. The merchant services management agent may, but need not, provide instructions to a trusted payment intermediary system to configure merchant account services as well.

In an implementation, the transaction confirmation management engine 506 implements a payment information confirmation agent that confirms payments for goods or services. The payment information confirmation agent may confirm whether or not a purchaser is authorized (by, e.g., a trusted payment intermediary) to pay for a good or service that is sold using a merchant service. In some implementations, the intermediary data interface engine 508 implements a trusted payment intermediary payment information confirmation agent that asks a trusted payment intermediary whether or not a payment is authorized. The trusted payment intermediary payment information confirmation agent may access one or more APIs supported by the trusted payment intermediary system.

In a specific implementation, the parameter datastore 510 stores merchant services parameters. In some implementations, the account datastore 512 stores merchant account information.

In various implementations, the merchant services management system 500 may operate to manage merchant services for one or more merchant systems. More particularly, the merchant services management system 500 may set up merchant account services and/or process instructions to modify and/or otherwise manage implementation of those merchant services. The parameter identification engine 502 may operate to implement a merchant services parameter providing agent that provides merchant services parameters to a payment processing integration system. The account services management engine 504 may operate to implement a merchant services management agent that manages merchant services in accordance with merchant service information provided, from, e.g., a payment processing integration system. Further, the transaction confirmation management engine 506 may operate to implement a payment information confirmation agent that confirms payments for goods or services.

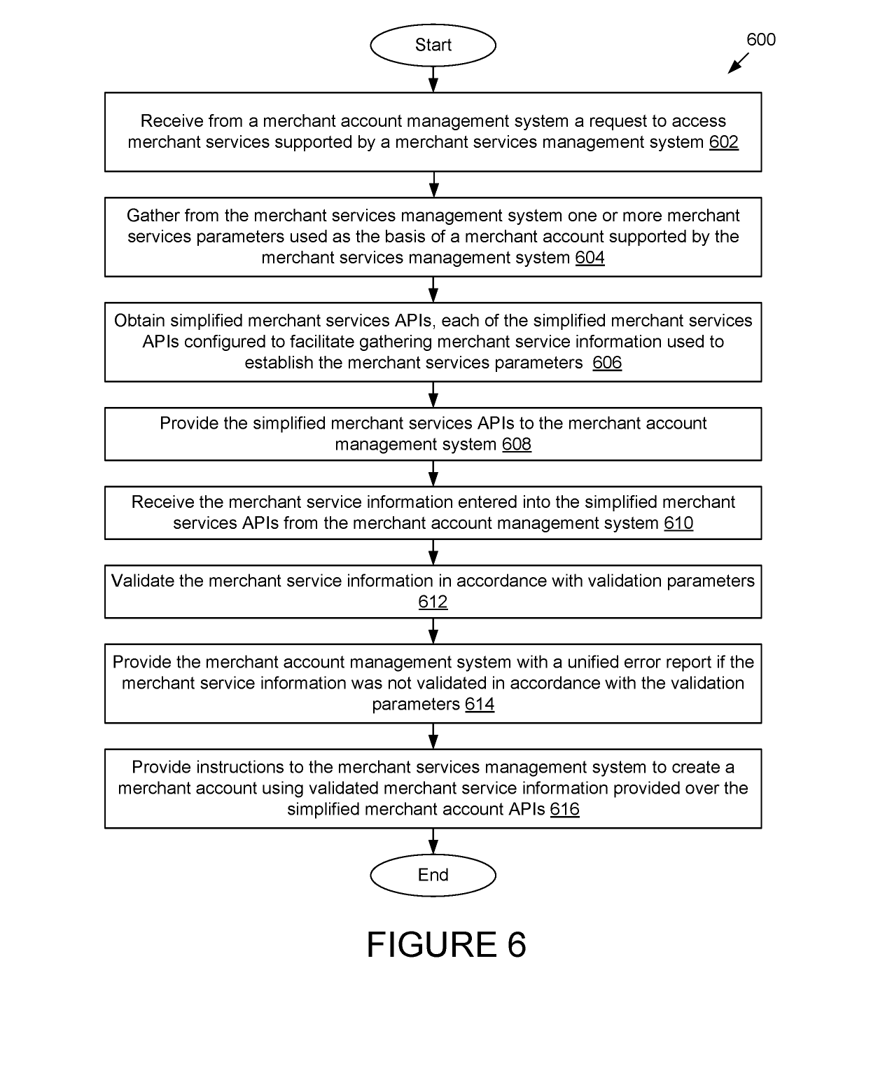

FIG. 6 shows an example of a flowchart 600 of a method for providing instructions to create a merchant account using validated merchant information provided over a simplified merchant account API, according to some implementations. The flowchart 600 is discussed in conjunction with the structures in the electronic payments system 100 shown in FIGS. 1A-1D, and the payment processing integration system 300 shown in FIG. 3. It is noted the flowchart 600 may include a greater or a lesser number of operations than those explicitly depicted, and that not all operations in the flowchart 600 may be necessary for various implementations.

At an operation 602, a request to access merchant services supported by a merchant services management system may be received. In various implementations, an access request agent that requests access to merchant services may be implemented by an electronic account login engine. The access request agent may provide login information that are used as the basis to access merchant services supported by a merchant services management system.

At an operation 604, one or more merchant services parameters may be gathered from the merchant services management system, where the one or more merchant services parameters are used as the basis of a merchant account supported by the merchant services management system. In an implementation, a merchant services parameter request agent that requests merchant services parameters from a merchant services management system may be implemented. The merchant services parameter request agent may be implemented by a payment processing integration system as part of its interface with the merchant services management system. The merchant services parameters may be used as the basis of one or more merchant accounts supported by the merchant services.

At an operation 606, one or more simplified merchant service APIs may that are configured to facilitate gathering merchant service information that is used to establish the merchant services parameters may be obtained. In an implementation, a simplified API gathering agent may be implemented by a simplified merchant services API engine. The simplified API gathering agent may identify one or more simplified merchant service APIs that are configured to facilitate gathering merchant service information that is used to establish the merchant services parameters. The simplified merchant service APIs may include data relevant to the merchant services information, such as data related to authorization protocols, merchant identities, payment management protocols, customer identities, and tokens used for merchant services. Advantageously, the simplified merchant service APIs may reduce complexity in management of merchant services.

At an operation 608, the simplified merchant services APIs may be provided to the merchant account management system. In some implementations, a simplified API providing agent may be implemented by a payment processing integration system. The simplified API providing agent may provide the simplified merchant services APIs to the merchant account management system.

At an operation 610, merchant service information entered into the simplified merchant services APIs may be received from the merchant account management system. In an implementation, a merchant services information providing agent may be implemented by a simplified merchant services API engine. The merchant services information providing agent may allow merchant services information to be transferred from the merchant account management system to a payment processing integration system.

At an operation 612, the merchant services information may be validated in accordance with one or more validation parameters. In an implementation, a merchant services information validation agent may be implemented by an electronic account information validation engine. The merchant services information validation agent may validate the merchant services information. In an implementation, the merchant services information validation agent may review and analyze the entire contents of the merchant services information to determine whether or not errors exist in the merchant services information. Advantageously, reviewing the entire contents of the merchant services information may provide the basis for a unified error report that identifies all errors in the merchant services information. At an operation 614, the merchant account management system may be provided with a unified error report if the merchant service information was not validated in accordance with the validation parameters.

At an operation 616, instructions to the merchant services management system to create a merchant account using validated merchant service information provided over the simplified merchant account APIs may be provided. In some implementations, a validated merchant services information providing agent supported by an electronic account error reporting engine may provide instructions to the merchant services management system to create a merchant account using validated merchant service information provided over the simplified merchant account APIs,

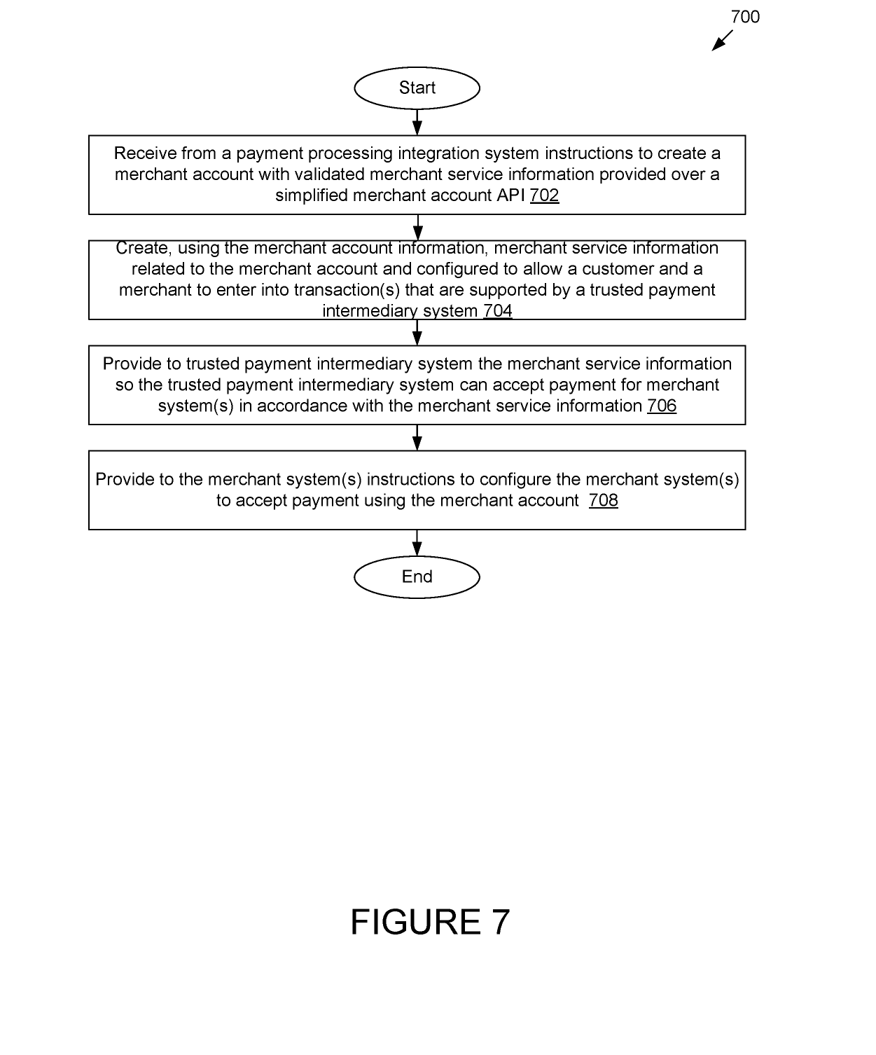

FIG. 7 shows an example of a flowchart 700 of a method for providing instructions to configure merchant system(s) to accept payment using a merchant account, according to some implementations. The flowchart 700 is discussed in conjunction with the structures in the electronic payments system 100 shown in FIGS. 1A-1D, and the merchant services management system 500 shown in FIG. 5. It is noted the flowchart 700 may include a greater or a lesser number of operations than those explicitly depicted, and that not all operations in the flowchart 700 may be necessary for various implementations.

At an operation 702, instructions to create a merchant account with validated merchant service information provided over a simplified merchant account API may be received from a payment processing integration system. In an implementation, a parameter identification engine may implement a merchant services parameter request agent to receive instructions to create a merchant account with validated merchant service information provided over a simplified merchant account API.

At an operation 704, merchant services information may be created using the merchant account information; the merchant services information may be related to the merchant account and configured to allow a customer and a merchant to enter into transaction(s) that are supported by a trusted payment intermediary system. In some implementations, an account management engine may implement a merchant services management agent to create using the merchant account information, a merchant service information related to the merchant account and configured to allow a customer and a merchant to enter into transaction(s) that are supported by a trusted payment intermediary system.

At an operation 706, the merchant service information may be provided to a trusted payment intermediary system so the trusted payment intermediary system can accept payment for merchant system(s) in accordance with the merchant service information. In a specific implementation, an intermediary data interface engine may implement a trusted intermediary system providing agent to Provide to trusted payment intermediary system the merchant service information so the trusted payment intermediary can accept payment for merchant system(s) in accordance with the merchant service information [0099] At an operation 708, instructions to configure merchant system(s) to accept payment using the merchant account may be provided to the merchant system(s). In some implementations, the transaction confirmation management engine 506 may implement a merchant system providing agent to provide to merchant system(s) instructions to configure the merchant system(s) to accept payment using the merchant account.

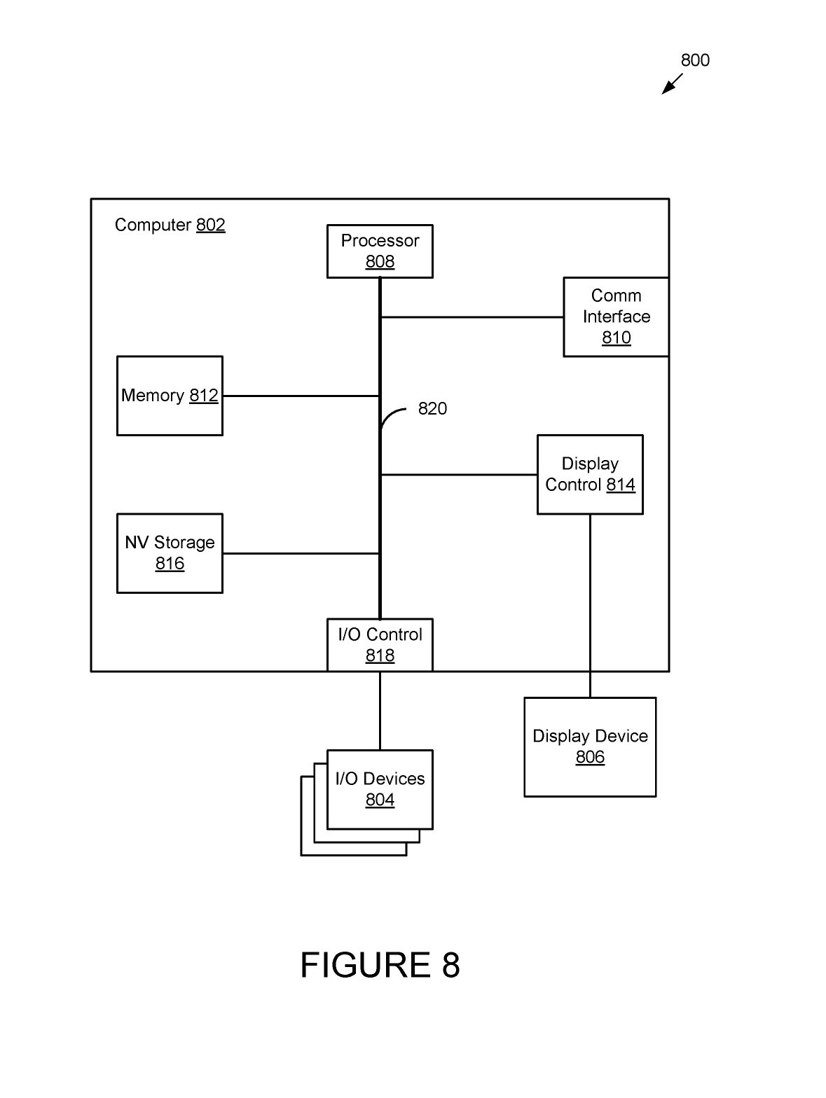

FIG. 8 shows a computer system 800, according to some embodiments. The computer system 800 may be a conventional computer system that may be used as a client computer system, such as a wireless client or a workstation, or a server computer system. The computer system 800 includes a computer 802, I/O devices 804, and a display device 806. The computer 802 includes a processor 808, a communications interface 810, memory 812, display controller 814, nonvolatile storage 816, and I/O controller 818. The computer 802 may be coupled to or include the I/O devices 804 and display device 806.

The computer 802 interfaces to external systems through the communications interface 810, which may include a modem or network interface. It will be appreciated that the communications interface 810 may be considered to be part of the computer system 800 or a part of the computer 802. The communications interface 810 may be an analog modem, ISDN modem, cable modem, token ring interface, satellite transmission interface (e.g. “direct PC”), or other interfaces for coupling a computer system to other computer systems.

The processor 808 may be, for example, a conventional microprocessor such as an Intel Pentium microprocessor or Motorola power PC microprocessor. The memory 812 is coupled to the processor 808 by a bus 820. The memory 812 may be Dynamic Random Access Memory (DRAM) and may also include Static RAM (SRAM). The bus 820 couples the processor 808 to the memory 812, also to the non-volatile storage 816, to the display controller 814, and to the I/O controller 818.

The I/O devices 812 may include a keyboard, disk drives, printers, a scanner, and other input and output devices, including a mouse or other pointing device. The display controller 814 may control in the conventional manner a display on the display device 806, which may be, for example, a cathode ray tube (CRT) or liquid crystal display (LCD). The display controller 814 and the I/O controller 818 may be implemented with conventional well-known technology.

The non-volatile storage 816 is often a magnetic hard disk, an optical disk, or another form of storage for large amounts of data. Some of this data is often written, by a direct memory access process, into memory 812 during execution of software in the computer 802. One of skill in the art will immediately recognize that the terms “machine-readable medium” or “computer-readable medium” includes any type of storage device that is accessible by the processor 808 and also encompasses a carrier wave that encodes a data signal.

The computer system 800 is one example of many possible computer systems that have different architectures. For example, personal computers based on an Intel microprocessor often have multiple buses, one of which may be an I/O bus for the peripherals and one that directly connects the processor 808 and the memory 812 (often referred to as a memory bus). The buses are connected together through bridge components that perform any necessary translation due to differing bus protocols.

Network computers are another type of computer system that may be used in conjunction with the teachings provided herein. Network computers do not usually include a hard disk or other mass storage, and the executable programs are loaded from a network connection into the memory 812 for execution by the processor 808. A Web TV system, which is known in the art, is also considered to be a computer system, but it may lack some of the features shown in FIG. 8, such as certain input or output devices. A typical computer system will usually include at least a processor, memory, and a bus coupling the memory to the processor.

Though FIG. 8 shows an example of the computer system 800, it is noted that the term “computer system,” as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor may be, for example, a general-purpose central processing unit (CPU), such as a microprocessor, or a special-purpose processor, such as a microcontroller.

The memory may include, by way of example but not limitation, random access memory (RAM), such as dynamic RAM (DRAM) and static RAM (SRAM). The memory may be local, remote, or distributed. As used in this paper, the term “computer-readable storage medium” is intended to include only physical media, such as memory. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus may also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage may be local, remote, or distributed. The non-volatile storage is optional because systems may be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used in this paper, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, the computer system 800 may be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus 820 may also couple the processor 808 to the communications interface 810. The communications interface 810 may include one or more input and/or output (I/O) devices. The I/O devices may include, by way of example but not limitation, a keyboard, a mouse or other pointing device, disk drives, printers, a scanner, and other I/O devices, including a display device. The display device 806 may include, by way of example but not limitation, a cathode ray tube (CRT), liquid crystal display (LCD), or some other applicable known or convenient display device. The communications interface 810 may include one or more of a modem or network interface. It will be appreciated that a modem or network interface may be considered to be part of the computer system 800. The communications interface 810 may include an analog modem, ISDN modem, cable modem, token ring interface, satellite transmission interface (e.g. “direct PC”), or other interfaces for coupling the computer system 800 to other computer systems. The communications interfaces 810 may enable computer systems and other devices to be coupled together in a network.

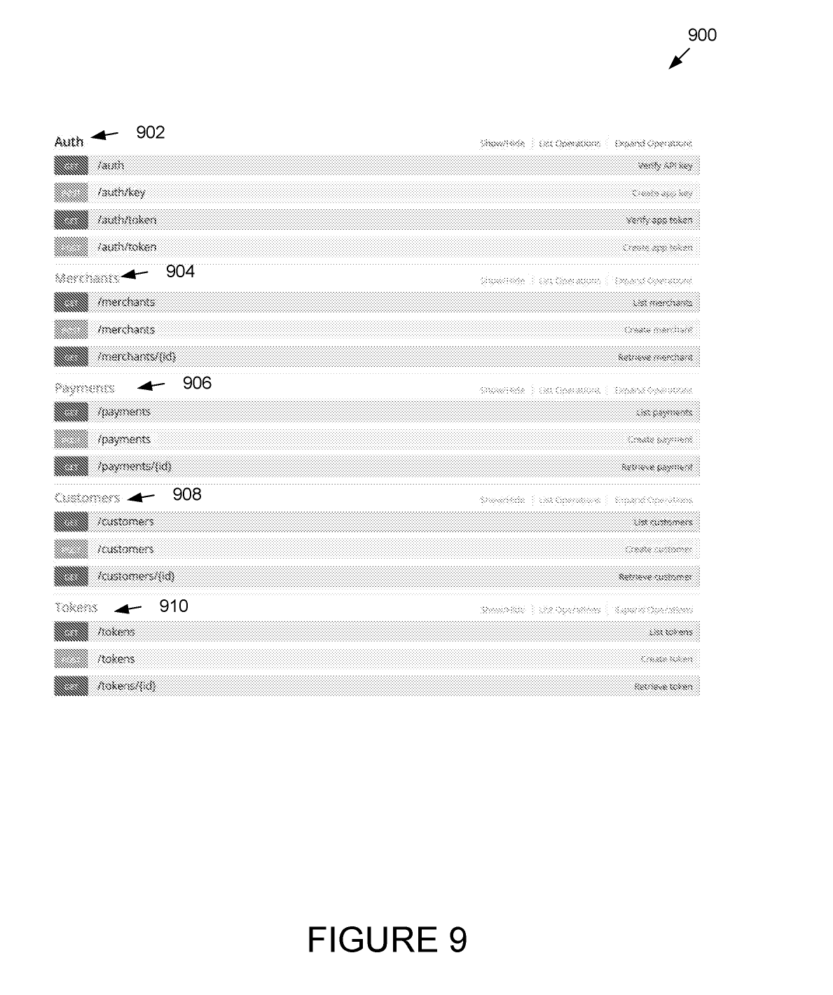

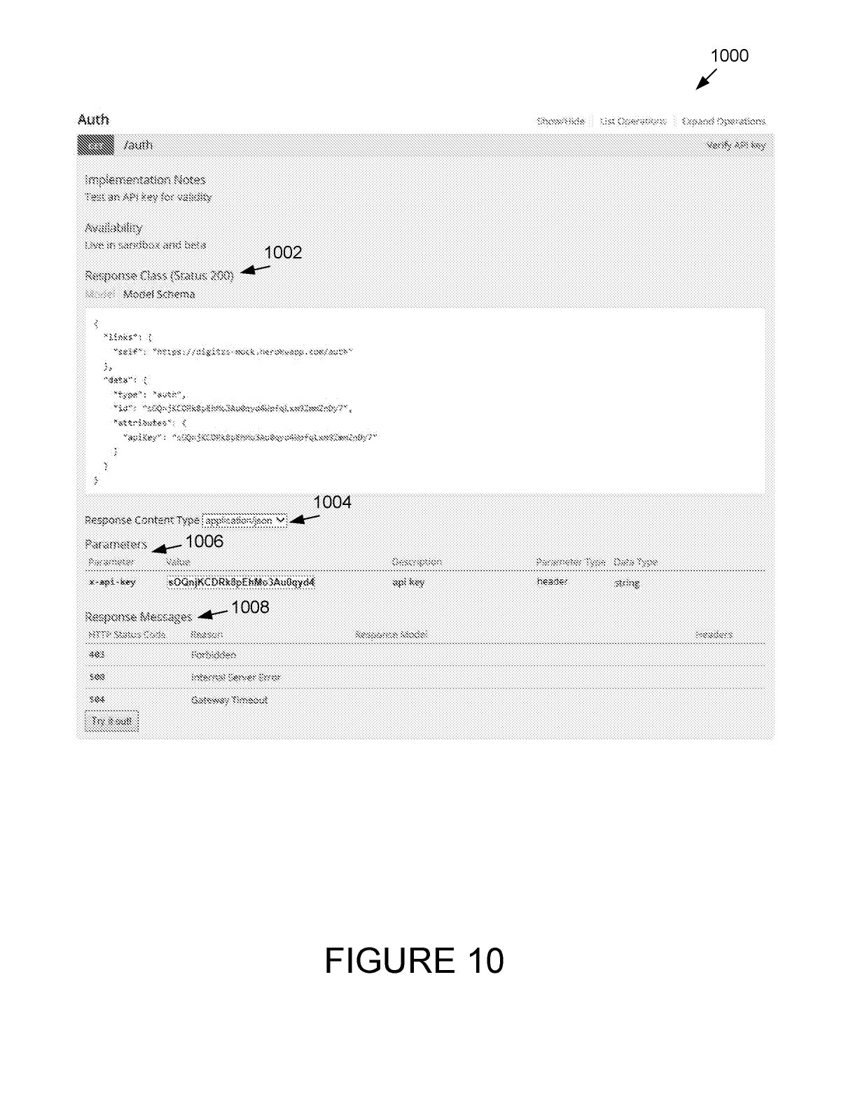

FIG. 9 shows an example of a screenshot 900 of a list of simplified APIs, according to some implementations. The screenshot 900 may include authorization management APIs 902, merchant management APIs 904, payment management APIs 906, customer management APIs 908, and token management APIs 910. Each of the simplified APIs may present a user with the minimal information needed to manage merchant services on a payment processing partner system. The simplified APIs may include REST APIs compatible with JSON formats, and need not include the complexity of SOAP APIs that are compatible with more complicated formats, such as XML. The discussion herein provides a high-level overview of the simplified APIs. The simplified APIs are further discussed in more detail in relation to FIGS. 10-25.

The authorization management APIs 902 may include a set of APIs configured to allow a merchant account management system to manage authorization protocols to a payment processing partner system. The authorization management APIs 902 may include a first API for verifying an API key, a second API for creating an application key, a third API for verifying an application token, and a fourth API for creating an application token. Each of the APIS may include REST APIs that are compatible with JSON formats. The APIs may allow the merchant management system to, e.g., verify API keys used for a specific operation, create application keys for applications used in transactions with merchants, verify application tokens for the applications, and create and/or otherwise manage application tokens.

The merchant management APIs 904 may include a set of APIs configured to allow the merchant account management system to establish and/or otherwise manage merchant accounts on the payment processing partner system. The merchant management APIs 904 may include a first API for listing merchants, a second API for creating a new merchant, and a third API for retrieving a specific merchant. Each of the APIS may include REST APIs that are compatible with JSON formats. The APIs may allow the merchant management system to list existing merchants of a merchant account service, create new merchants, and retrieve specific merchants.

The payment management APIs 906 may include a set of APIs configured to allow the merchant account management system to manage payments processes of merchant accounts on the payment processing partner system. The payment management APIs 906 may include a first API for listing payment processes, a second API for creating a payment process, and a third API for retrieving a specific payment process. Each of the APIS may include REST APIs that are compatible with JSON formats. The APIs may allow the merchant management system to list existing payment processes for a merchant account service, create new payment processes, and retrieve specific payment processes.

The customer management APIs 908 may include a set of APIs configured to allow the merchant account management system to manage customers processes related to merchant accounts on the payment processing partner system. The customer management APIs 908 may include a first API for listing customer accounts, a second API for creating a customer account, and a third API for retrieving a specific customer account. Each of the APIS may include REST APIs that are compatible with JSON formats. The APIs may allow the merchant management system to list existing customer accounts for a merchant account service, create new customer accounts, and retrieve specific customer accounts.

The token management APIs 910 may include a set of APIs configured to allow the merchant account management system to manage tokens for transactions related to merchant accounts on the payment processing partner system. The token management APIs 910 may include a first API for listing tokens, a second API for creating a new token, and a third API for retrieving a specific token. Each of the APIS may include REST APIs that are compatible with JSON formats. The APIs may allow the merchant management system to list tokens for a merchant account service, create new tokens, and retrieve specific tokens.

FIG. 10 shows an example of a screenshot 1000 of a simplified API for verifying an API key, according to some implementations. The screenshot 1000 shows, in relevant part, a response class box 1002, a response content type menu 1004, a parameter reference box 1006, and a response message box 1008. The response class box 1002 may display a class (e.g., a JSON class) corresponding to a response to a request to verify an API key. The response content type menu 1004 may include a menu that shows the response content type to a request to verify an API key. The parameter reference box 1006 may include parameters to a request to verify an API key. The response message box 1008 may display a list of response messages to a request to verify an API key.

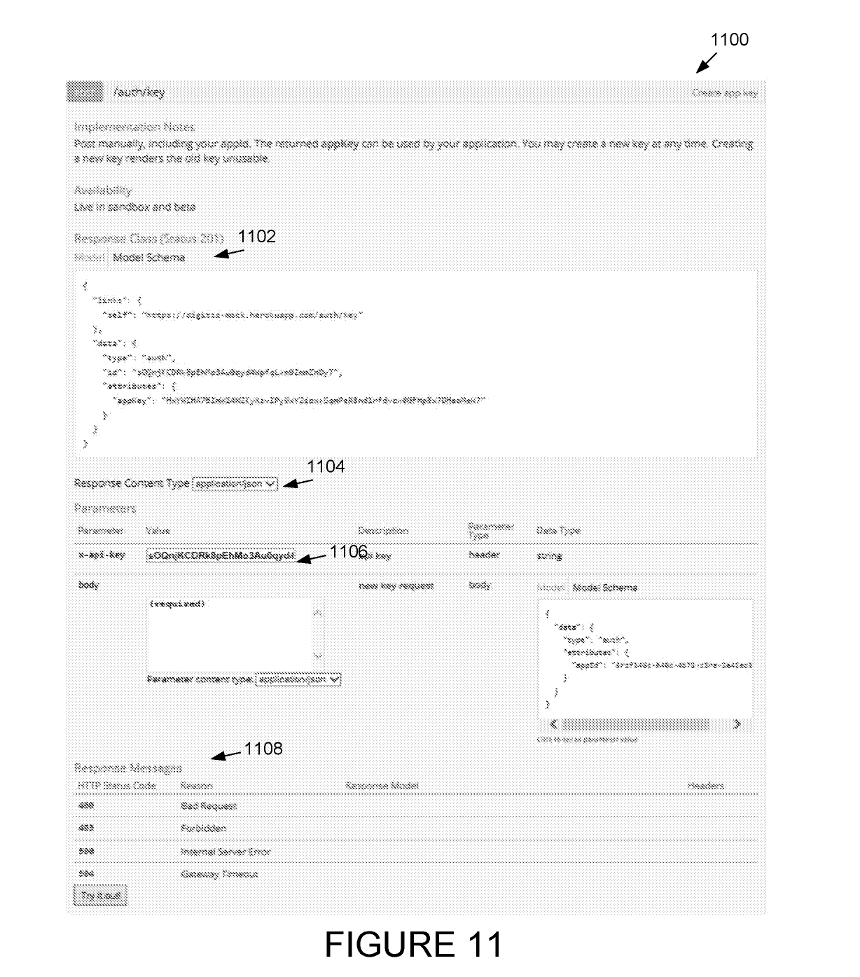

FIG. 11 shows an example of a screenshot 1100 of a simplified API for creating an application key, according to some implementations. The screenshot 1100 shows, in relevant part, a response class box 1102, a response content type menu 1104, a parameter reference box 1106, and a response message box 1108. The response class box 1102 may display a class (e.g., a JSON class) corresponding to a response to a request to create an application key. The response content type menu 1104 may include a menu that shows the response content type to a request to create an application key. The parameter reference box 1106 may include parameters to a request to create an application key. The response message box 1108 may display a list of response messages to a request to create an application key.

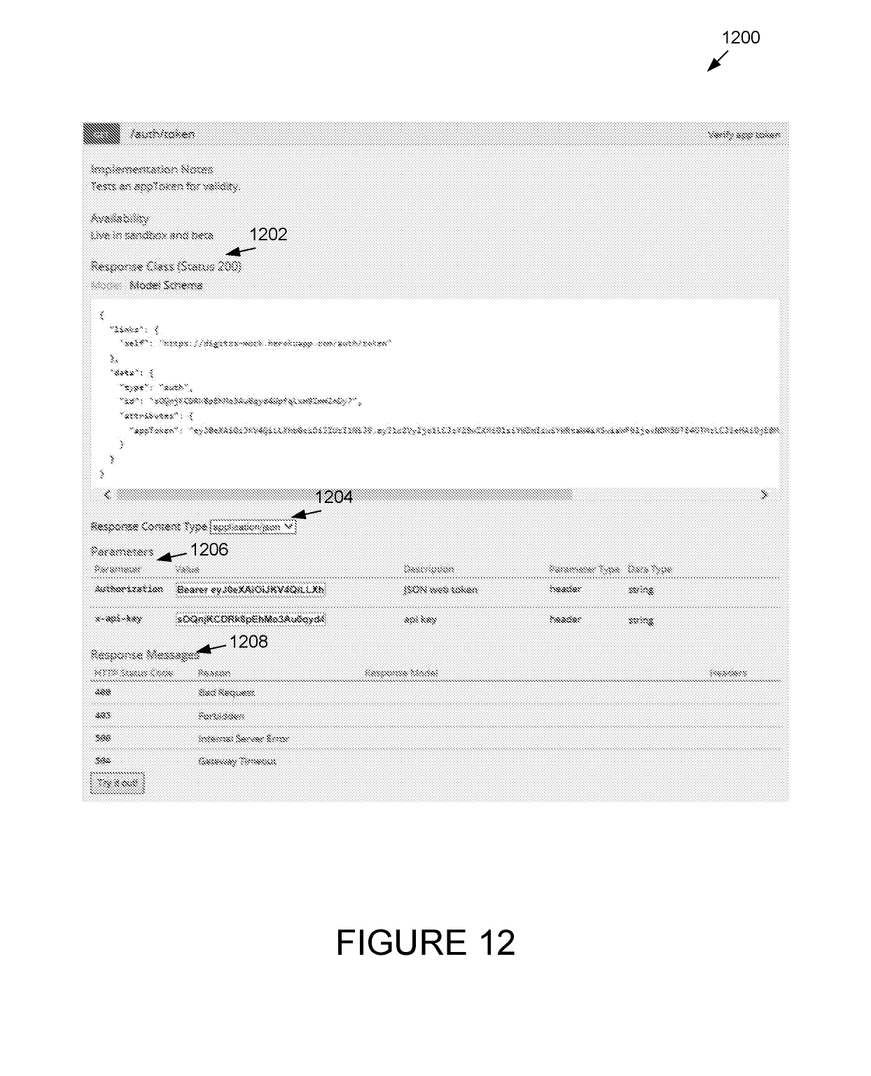

FIG. 12 shows an example of a screenshot 1200 of a simplified API for verifying an application token, according to some implementations. The screenshot 1200 shows, in relevant part, a response class box 1202, a response content type menu 1204, a parameter reference box 1206, and a response message box 1208. The response class box 1202 may display a class (e.g., a JS ON class) corresponding to a response to a request to verify an application token. The response content type menu 1204 may include a menu that shows the response content type to a request to verify an application token. The parameter reference box 1206 may include parameters to a request to verify an application token. The response message box 1208 may display a list of response messages to a request to verify an application token.

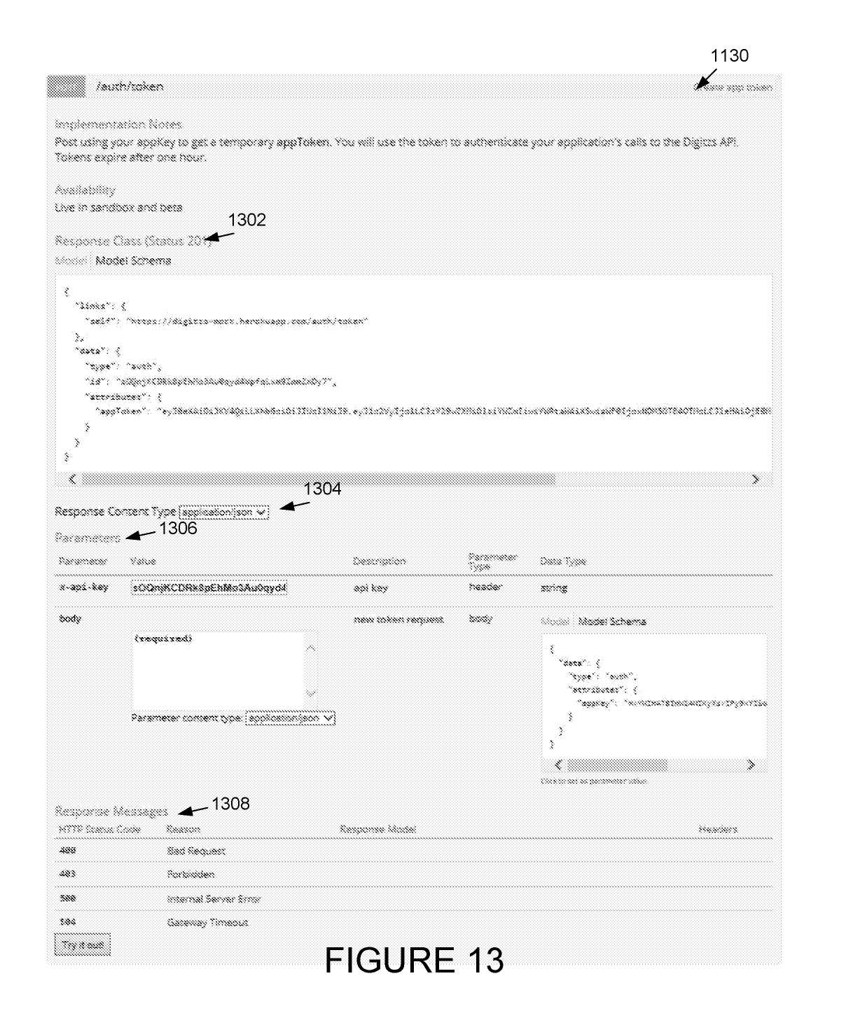

FIG. 13 shows an example of a screenshot 1300 of a simplified API for creating an application token, according to some implementations. The screenshot 1300 shows, in relevant part, a response class box 1302, a response content type menu 1304, a parameter reference box 1306, and a response message box 1308. The response class box 1302 may display a class (e.g., a JS ON class) corresponding to a response to a request to create an application token. The response content type menu 1304 may include a menu that shows the response content type to a request to create an application token. The parameter reference box 1306 may include parameters to a request to create an application token. The response message box 1308 may display a list of response messages to a request to create an application token.

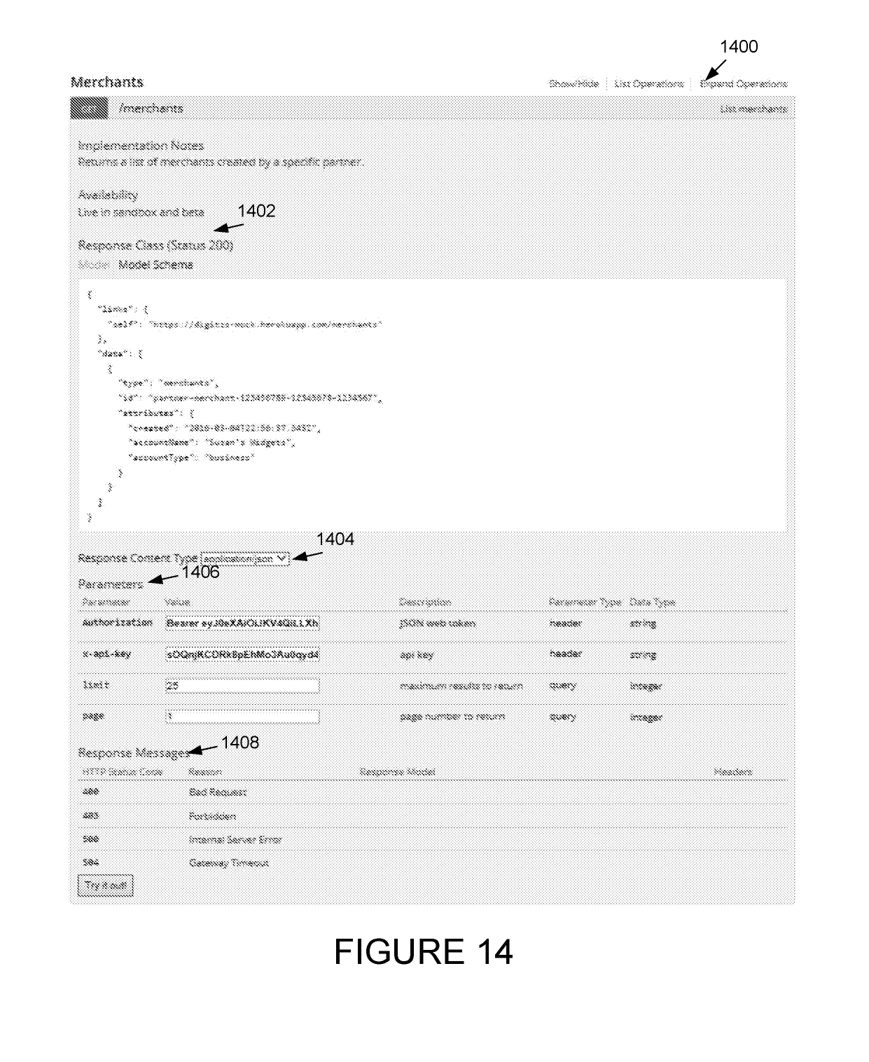

FIG. 14 shows an example of a screenshot 1400 of a simplified API for listing merchants, according to some implementations. The screenshot 1400 shows, in relevant part, a response class box 1402, a response content type menu 1404, a parameter reference box 1406, and a response message box 1408. The response class box 1402 may display a class (e.g., a JSON class) corresponding to a response to a request to list merchants. The response content type menu 1404 may include a menu that shows the response content type to a request to list merchants. The parameter reference box 1406 may include parameters to a request to list merchants. The response message box 1408 may display a list of response messages to a request to list merchants.

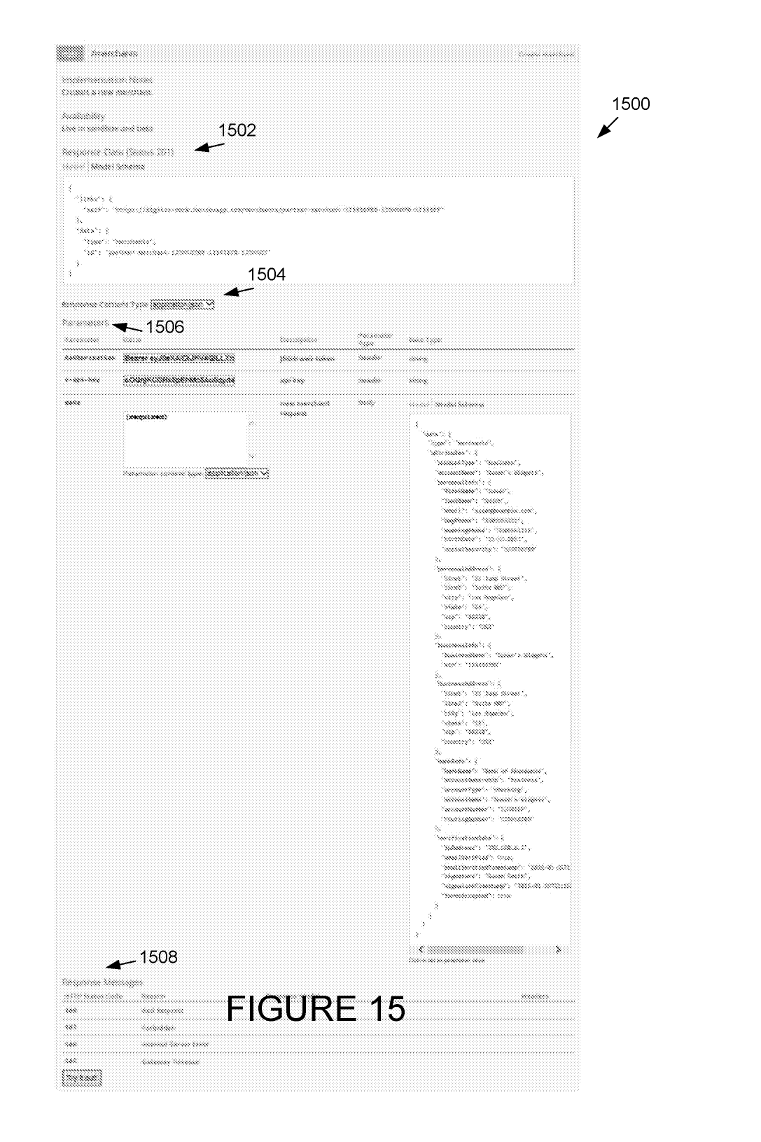

FIG. 15 shows an example of a screenshot 1500 of a simplified API for creating merchants, according to some implementations. The screenshot 1500 shows, in relevant part, a response class box 1502, a response content type menu 1504, a parameter reference box 1506, and a response message box 1508. The response class box 1502 may display a class (e.g., a JSON class) corresponding to a response to a request to create merchants. The response content type menu 1504 may include a menu that shows the response content type to a request to create merchants. The parameter reference box 1506 may include parameters to a request to create merchants. The response message box 1508 may display a list of response messages to a request to create merchants.

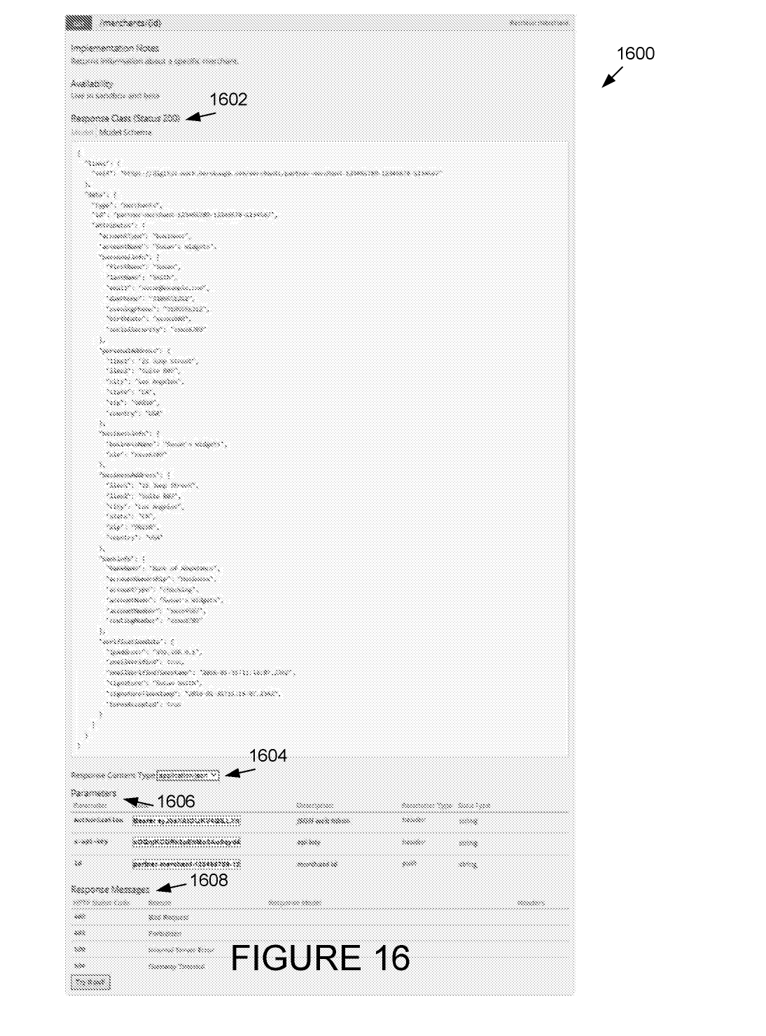

FIG. 16 shows an example of a screenshot 1600 of a simplified API for retrieving merchants, according to some implementations. The screenshot 1600 shows, in relevant part, a response class box 1602, a response content type menu 1604, a parameter reference box 1606, and a response message box 1608. The response class box 1602 may display a class (e.g., a JSON class) corresponding to a response to a request to retrieve merchants. The response content type menu 1604 may include a menu that shows the response content type to a request to retrieve merchants. The parameter reference box 1606 may include parameters to a request to retrieve merchants. The response message box 1608 may display a list of response messages to a request to retrieve merchants.

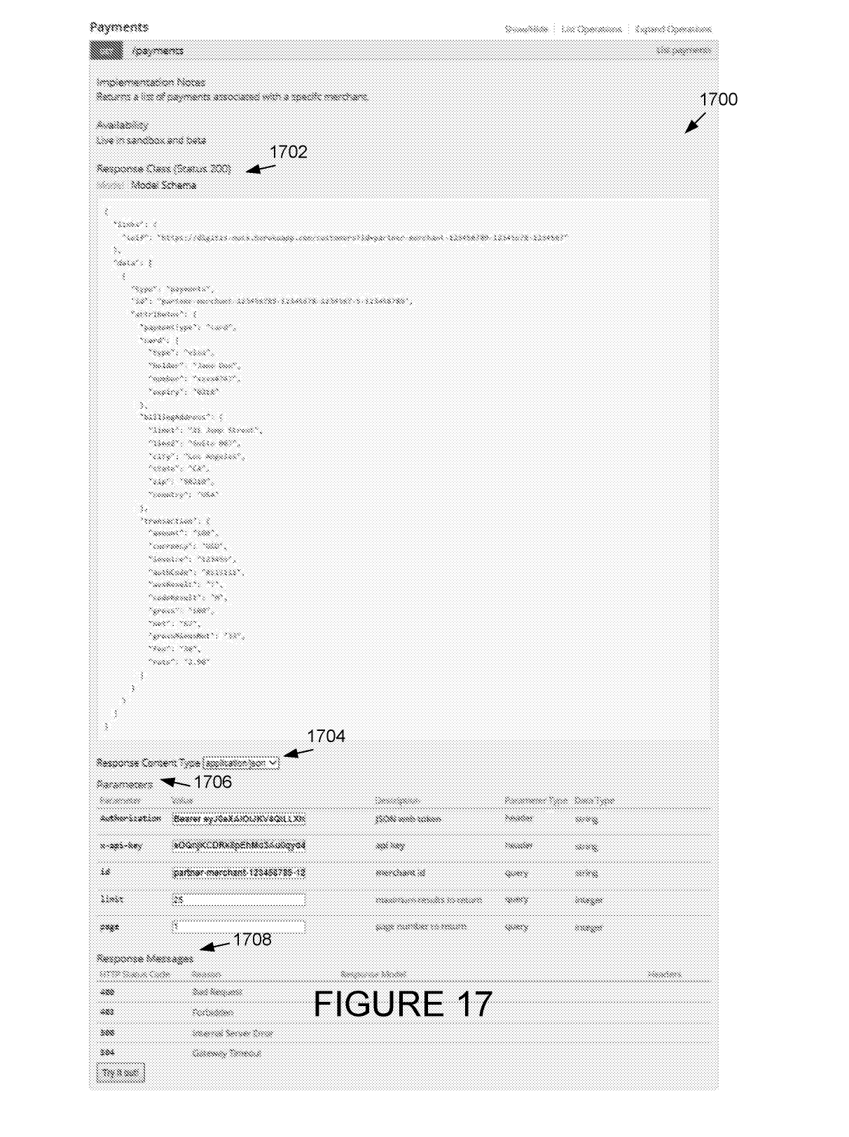

FIG. 17 shows an example of a screenshot 1700 of a simplified API for listing payments, according to some implementations. The screenshot 1700 shows, in relevant part, a response class box 1702, a response content type menu 1704, a parameter reference box 1706, and a response message box 1708. The response class box 1702 may display a class (e.g., a JSON class) corresponding to a response to a request to list payments. The response content type menu 1704 may include a menu that shows the response content type to a request to list payments. The parameter reference box 1706 may include parameters to a request to list payments. The response message box 1708 may display a list of response messages to a request to list payments.

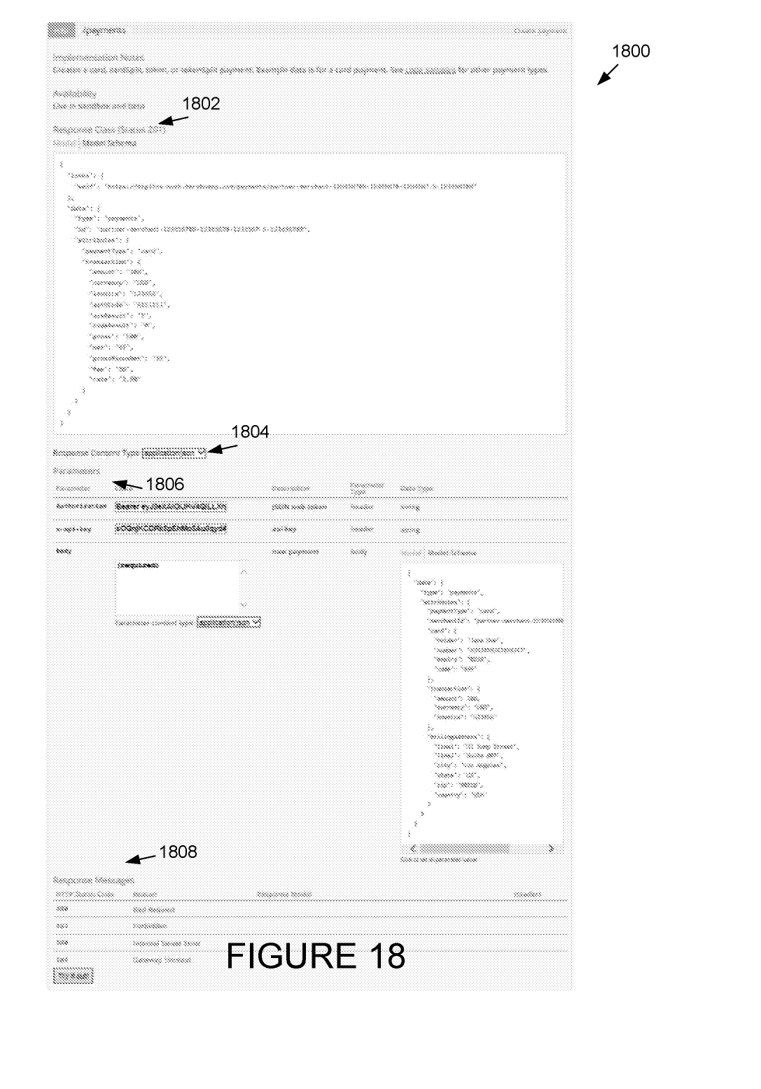

FIG. 18 shows an example of a screenshot 1800 of a simplified API for creating payments, according to some implementations. The screenshot 1800 shows, in relevant part, a response class box 1802, a response content type menu 1804, a parameter reference box 1806, and a response message box 1808. The response class box 1802 may display a class (e.g., a JSON class) corresponding to a response to a request to create payments. The response content type menu 1804 may include a menu that shows the response content type to a request to create payments. The parameter reference box 1806 may include parameters to a request to create payments. The response message box 1808 may display a list of response messages to a request to create payments.

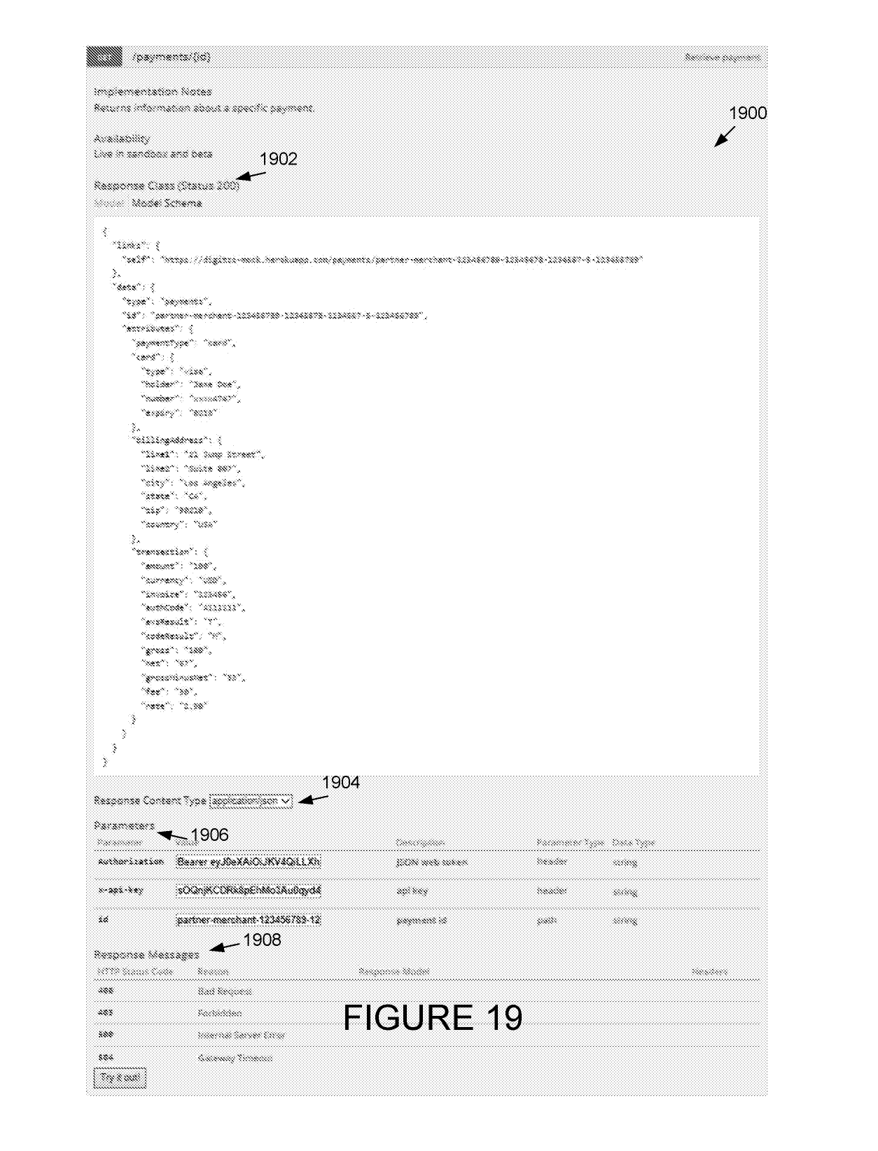

FIG. 19 shows an example of a screenshot 1900 of a simplified API for retrieving payments, according to some implementations. The screenshot 1900 shows, in relevant part, a response class box 1902, a response content type menu 1904, a parameter reference box 1906, and a response message box 1908. The response class box 1902 may display a class (e.g., a JSON class) corresponding to a response to a request to retrieve payments. The response content type menu 1904 may include a menu that shows the response content type to a request to retrieve payments. The parameter reference box 1906 may include parameters to a request to retrieve payments. The response message box 1908 may display a list of response messages to a request to retrieve payments.

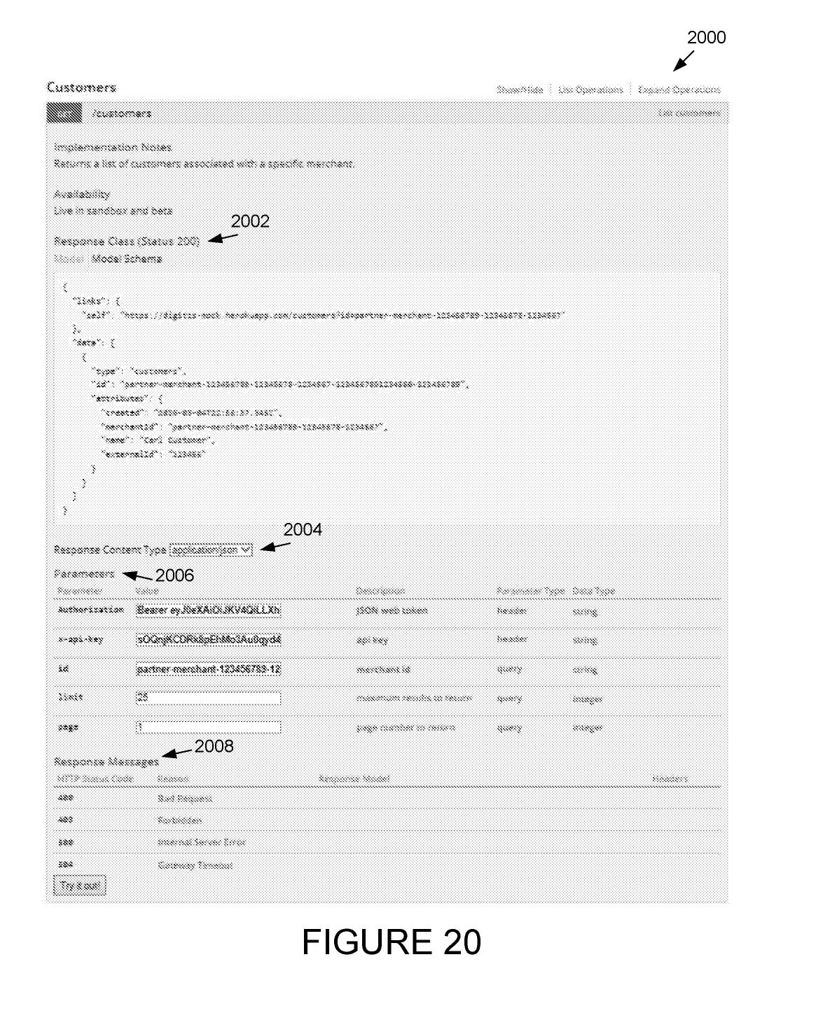

FIG. 20 shows an example of a screenshot 2000 of a simplified API for listing customers, according to some implementations. The screenshot 2000 shows, in relevant part, a response class box 2002, a response content type menu 2004, a parameter reference box 2006, and a response message box 2008. The response class box 2002 may display a class (e.g., a JSON class) corresponding to a response to a request to list customers. The response content type menu 2004 may include a menu that shows the response content type to a request to list customers. The parameter reference box 2006 may include parameters to a request to list customers. The response message box 2008 may display a list of response messages to a request to list customers.

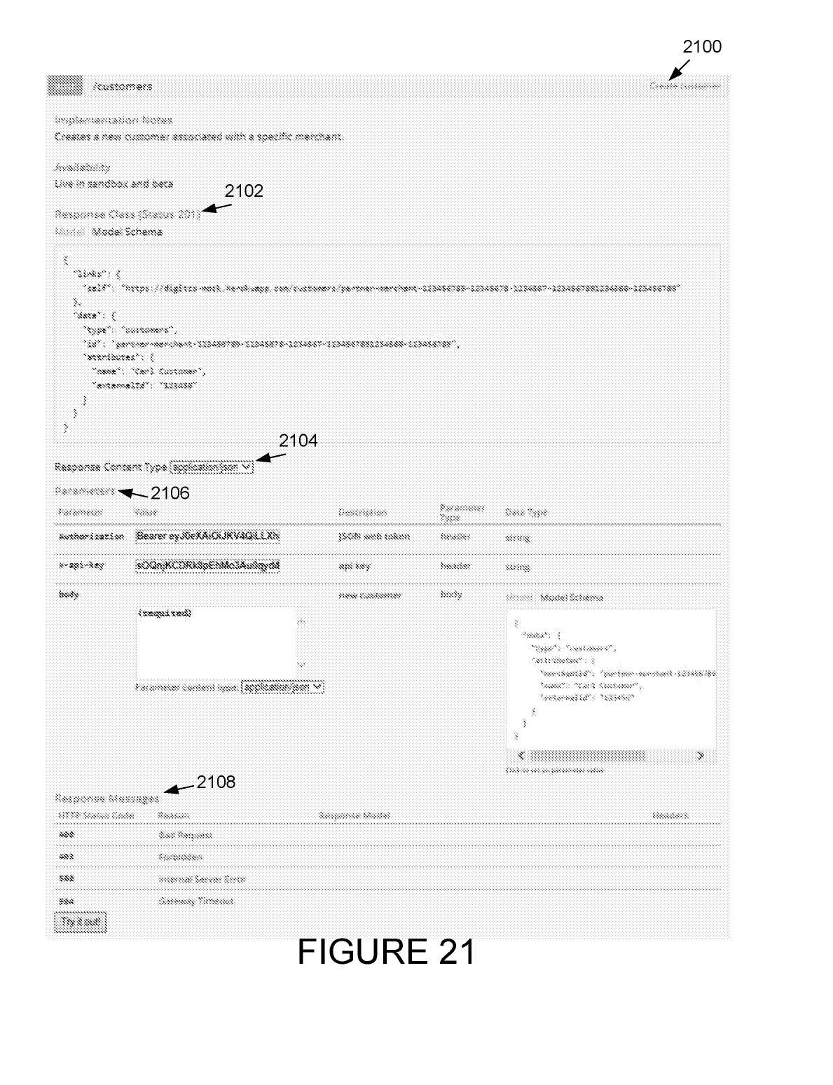

FIG. 21 shows an example of a screenshot 2100 of a simplified API for creating customers, according to some implementations. The screenshot 2100 shows, in relevant part, a response class box 2102, a response content type menu 2104, a parameter reference box 2106, and a response message box 2108. The response class box 2102 may display a class (e.g., a JSON class) corresponding to a response to a request to create customers. The response content type menu 2104 may include a menu that shows the response content type to a request to create customers. The parameter reference box 2106 may include parameters to a request to create customers. The response message box 2108 may display a list of response messages to a request to create customers.

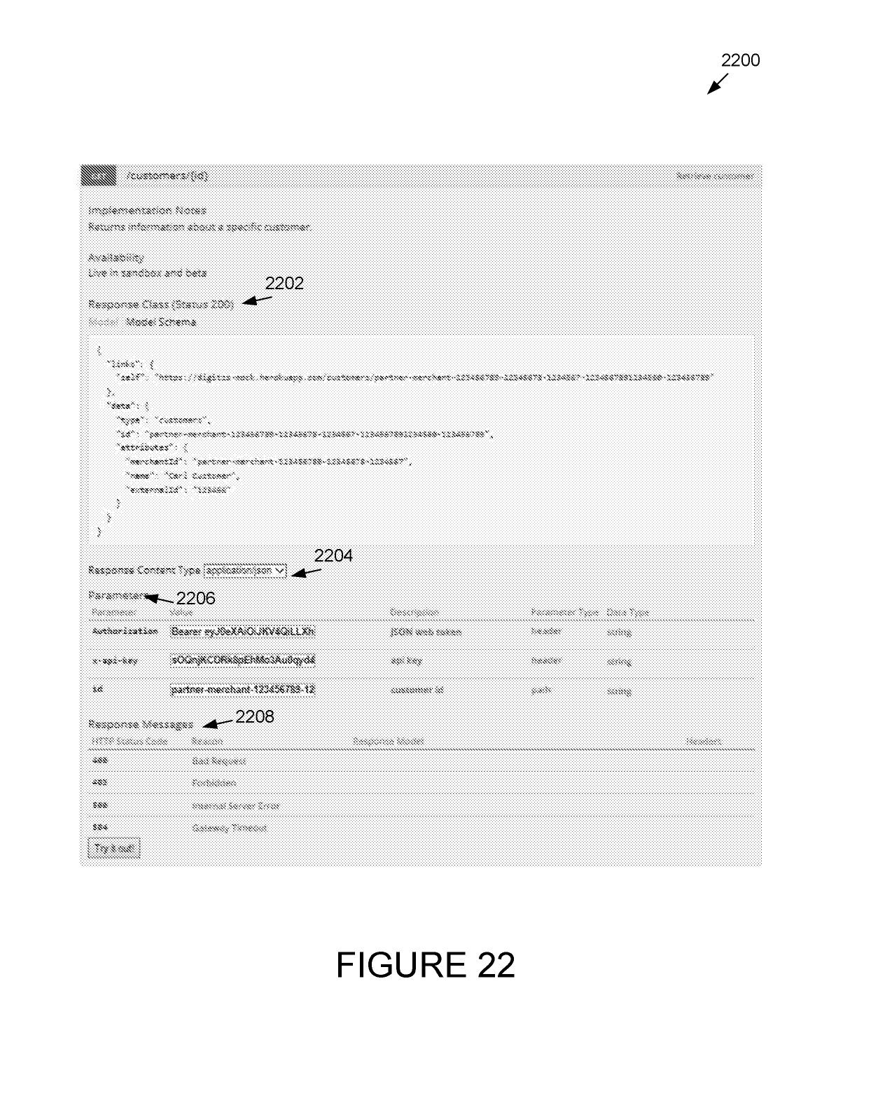

FIG. 22 shows an example of a screenshot 2200 of a simplified API for retrieving customers, according to some implementations. The screenshot 2200 shows, in relevant part, a response class box 2202, a response content type menu 2204, a parameter reference box 2206, and a response message box 2208. The response class box 2202 may display a class (e.g., a JSON class) corresponding to a response to a request to retrieve customers. The response content type menu 2204 may include a menu that shows the response content type to a request to retrieve customers. The parameter reference box 2206 may include parameters to a request to retrieve customers. The response message box 2208 may display a list of response messages to a request to retrieve customers.

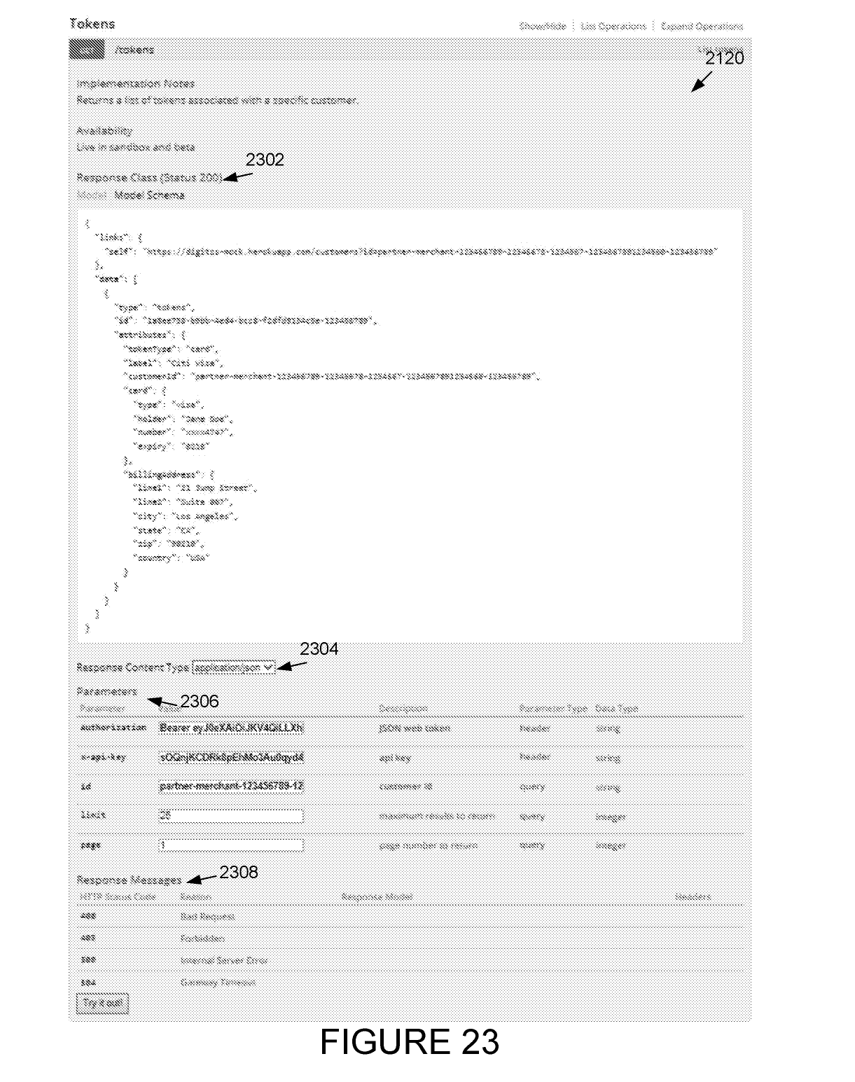

FIG. 23 shows an example of a screenshot 2300 of a simplified API for listing tokens, according to some implementations. The screenshot 2300 shows, in relevant part, a response class box 2302, a response content type menu 2304, a parameter reference box 2306, and a response message box 2308. The response class box 2302 may display a class (e.g., a JSON class) corresponding to a response to a request to list tokens. The response content type menu 2304 may include a menu that shows the response content type to a request to list tokens. The parameter reference box 2306 may include parameters to a request to list tokens. The response message box 2308 may display a list of response messages to a request to list tokens.

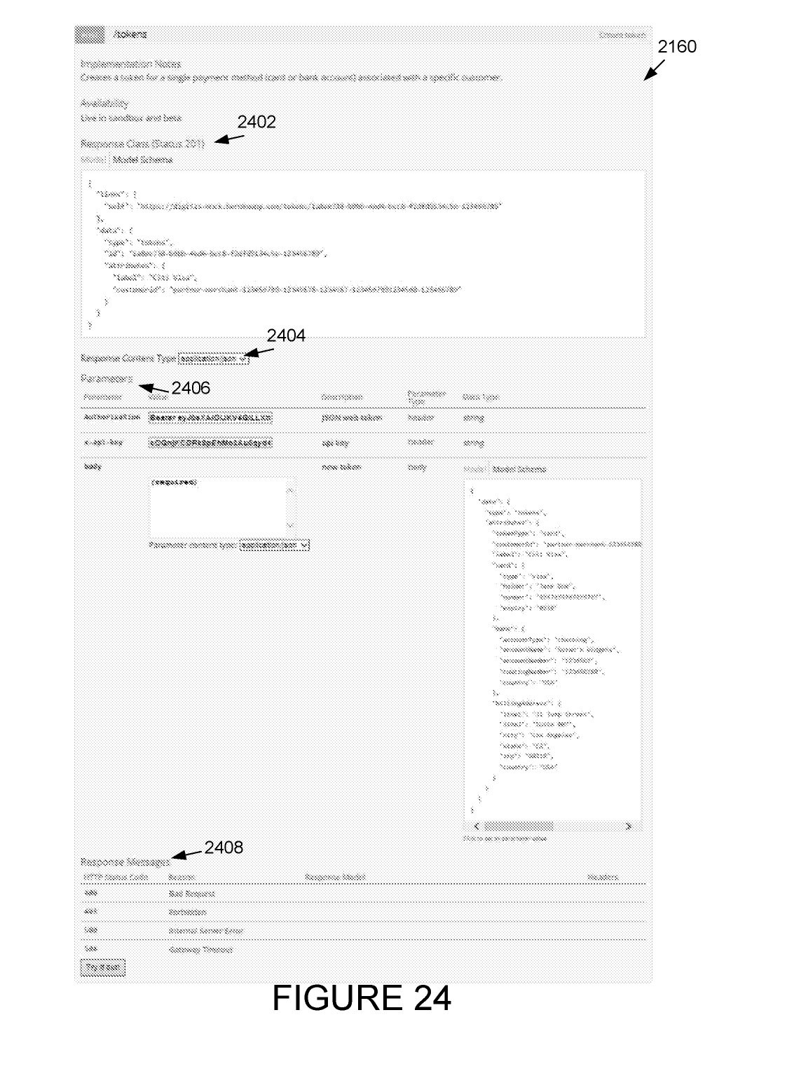

FIG. 24 shows an example of a screenshot 2400 of a simplified API for creating tokens, according to some implementations. The screenshot 2400 shows, in relevant part, a response class box 2402, a response content type menu 2404, a parameter reference box 2406, and a response message box 2408. The response class box 2402 may display a class (e.g., a JSON class) corresponding to a response to a request to create tokens. The response content type menu 2404 may include a menu that shows the response content type to a request to create tokens. The parameter reference box 2406 may include parameters to a request to create tokens. The response message box 2408 may display a list of response messages to a request to create tokens.

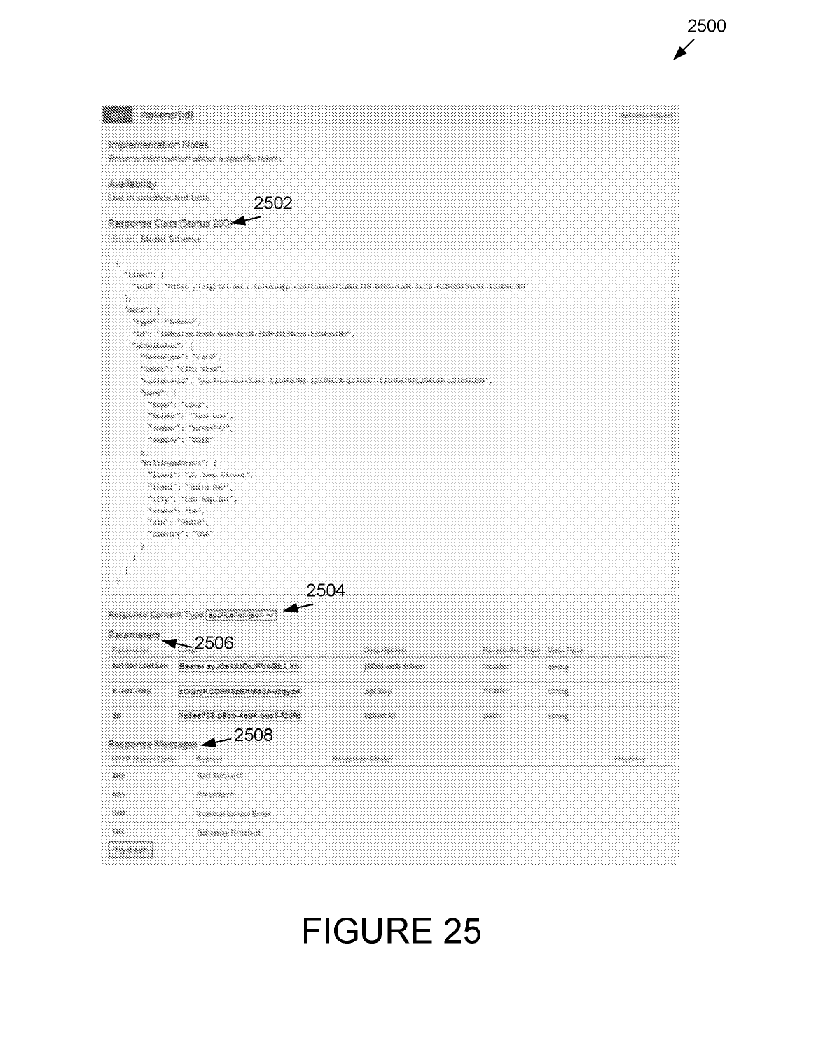

FIG. 25 shows an example of a screenshot 2500 of a simplified API for retrieving tokens, according to some implementations. The screenshot 2500 shows, in relevant part, a response class box 2502, a response content type menu 2504, a parameter reference box 2506, and a response message box 2508. The response class box 2502 may display a class (e.g., a JSON class) corresponding to a response to a request to retrieve tokens. The response content type menu 2504 may include a menu that shows the response content type to a request to retrieve tokens. The parameter reference box 2506 may include parameters to a request to retrieve tokens. The response message box 2508 may display a list of response messages to a request to retrieve tokens.

Several components described in this paper, including clients, servers, and engines, may be compatible with or implemented using a cloud-based computing system. As used in this paper, a cloud-based computing system is a system that provides computing resources, software, and/or information to client devices by maintaining centralized services and resources that the client devices may access over a communication interface, such as a network. The cloud-based computing system may involve a subscription for services or use a utility pricing model. Users may access the protocols of the cloud-based computing system through a web browser or other container application located on their client device.

This paper describes techniques that those of skill in the art may implement in numerous ways. For instance, those of skill in the art may implement the techniques described in this paper using a process, an apparatus, a system, a composition of matter, a computer program product embodied on a computer-readable storage medium, and/or a processor, such as a processor configured to execute instructions stored on and/or provided by a memory coupled to the processor. Unless stated otherwise, a component such as a processor or a memory described as being configured to perform a task may be implemented as a general component that is configured to perform the task at a given time or a specific component that is manufactured to perform the task. As used in this paper, the term ‘processor’ refers to one or more devices, circuits, and/or processing cores configured to process data, such as computer program instructions.

A detailed description of one or more implementations of the invention is provided in this paper along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus may be specially constructed for the required purposes, or it may comprise a general-purpose computer selectively activated or reconfigured by a computer program stored in the computer. Such a computer program may be stored in a computer-readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus. Although the foregoing implementations have been described in some detail for purposes of clarity of understanding, implementations are not necessarily limited to the details provided. FIG. 9 shows an example of a screenshot of a list of simplified APIs, according to some implementations.

What is claimed is:

1. A system comprising:
an electronic parameter request engine configured to gather one or more services parameters, each of the one or more services parameters providing a basis for services information obtained from a services management system;
a simplified services engine Application Programming Interface (API) engine configured to:
obtain one or more simplified services APIs, each of the one or more simplified services APIs configured to facilitate gathering services information used to establish the services parameters;
provide the simplified services APIs to be displayed in an account management system;
receive the simplified services APIs to be displayed in an account management system;
an electronic account information validation engine configured to:
obtain one or more validation parameters, each of the one or more validation parameters configured to provide a basis for validating the services information;
evaluate the services for validation in accordance with the validation parameters;
an electronic account error reporting engine configured to provide, if the services information was not validated in accordance with the validation parameters, a unified error report based on the validation parameters, the unified error report identifying all errors in the services information
an electronic account instruction management engine configured to provide instructions to create an account using validated services information provided over the simplified services APIs.

2. The system of claim 1, wherein the simplified services APIs comprise simplified services authorization APIs.

3. The system of claim 1, wherein the simplified services APIs comprise simplified services merchant identification APIs.

4. The system of claim 1, wherein the simplified services APIs comprise simplified services payment management APIs.

5. The system of claim 1, wherein the simplified services APIs comprise simplified services customer identification APIs.

6. The system of claim 1, wherein the simplified services APIs comprise simplified services token management APIs.

7. The system of claim 1, wherein the simplified services APIs are implemented using Representational State Transfer (REST) protocols that are compatible with a JavaScript Object Notation (JSON) format.

8. The system of claim 1, further comprising an account services management engine configured to create, using the account information, services information related to the account, the services information configured to allow a customer and a merchant to enter into a transaction that is supported by a trusted intermediary payment system.

9. The system of claim 8, further comprising an intermediary data interface engine configured to provide to the trusted intermediary payment system the services information so that the trusted payment intermediary system can accept payment for one or more merchant systems associated with the merchant in accordance with the services information.

10. The system of claim 9, further comprising a transaction confirmation management engine configured to provide to the one or more systems instructions to configure the one or more merchant systems to accept payment using the account.

11. A method comprising:
gathering one or services parameters, each of the one or more services parameters providing a basis for services information obtained from a services management system;
obtaining one or more simplified services Application Programming Interfaces (APIs), each of the one or more simplified services APIs configured to facilitate gathering services information used to establish the services parameters;
providing the simplified services APIs to be displayed in an account management system;
receiving the simplified services APIs to be displayed in an account management system;
obtaining one or more validation parameters, each of the one or more validation parameters configured to provide a basis for validating the services information;
evaluating the services for validation in accordance with the validation parameters;
if the services information was not validated in accordance with the validation parameters, providing a unified error report based on the validation parameters, the unified error report identifying all errors in the services information;
providing instructions to create an account using validated services information provided over the simplified services APIs.

12. The method of claim 11, wherein the simplified services APIs comprise simplified services authorization APIs.

13. The method of claim 11, wherein the simplified services APIs comprise simplified services merchant identification APIs.

14. The method of claim 11, wherein the simplified services APIs comprise simplified services payment management APIs.

15. The method of claim 11, wherein the simplified services APIs comprise simplified services customer identification APIs.

16. The method of claim 11, wherein the simplified services APIs comprise simplified services token management APIs.

17. The method of claim 11, wherein the simplified services APIs are implemented using Representational State Transfer (REST) protocols that are compatible with a JavaScript Object Notation (JSON) format.

18. The method of claim 11, further comprising creating, using the account information, services information related to the account, the services information configured to allow a customer and a merchant to enter into a transaction that is supported by a trusted intermediary payment system.

19. The method of claim 18, further comprising providing to the trusted intermediary payment system the services information so that the trusted payment intermediary system can accept payment for one or more merchant systems associated with the merchant in accordance with the services information.

20. The method of claim 19, further comprising providing to the one or more systems instructions to configure the one or more merchant systems to accept payment using the account.
